(19) United States
(12) Patent Application Publication
(10) Pub. No.: US 2014/0173101 A1
(43) Pub. Date: Jun. 19, 2014

(54) CALCULATOR, COMMUNICATION CONTROL METHOD, AND COMPUTER-READABLE RECORDING MEDIUM

(71) Applicant: FUJITSU LIMITED, Kawasaki-shi (JP)

(72) Inventor: Takahiro SAYAMA, Takaoka (JP)

(73) Assignee: FUJITSU LIMITED, Kawasaki-shi (JP)

(21) Appl. No.: 14/096,635

(22) Filed: Dec. 4, 2013

(30) Foreign Application Priority Data
Dec. 14, 2012 (JP) 2012-273987

(51) Int. Cl. H04L 29/08; H04L 12/26

(52) U.S. Cl. CPC H04L 67/16; H04L 43/0811
USPC 709/224

(57) ABSTRACT

A calculator includes communication devices, a detection unit, and a communication control unit. The detection unit performs communication among the plurality of communication devices connected to the same segment in a network, to thereby detect division of a network connected to each communication device. In the case division of the network is detected by the detection unit, the communication control unit generates information about a correspondence relationship between each communication appliance and an appliance in a reachable network. The communication control unit performs communication between a communication device and an appliance in a network based on the information about a correspondence relationship.

### CROSS-REFERENCE TO RELATED APPLICATION

This application is based upon and claims the benefit of priority of the prior Japanese Patent Application No. 2012-273987, filed on Dec. 14, 2012, the entire contents of which are incorporated herein by reference.

### FIELD

The embodiments discussed herein are directed to a calculator and the like.

### BACKGROUND

In recent years, there is a technique of making the communication path of a network to which a self system is connected redundant by using a plurality of NICs (Network Interface Cards) and of improving the reliability of the overall communication. In the following, examples of active/standby teaming and load balancing teaming will be described.

First, an example of the active/standby teaming will be described. The active/standby teaming is a communication mode of making a plurality of NICs connected to a signal network segment redundant, using one of the plurality of NICs for communication, and causing the rest of the NICs to be in a wait state. FIG. 30 is a system configuration diagram for describing the active/standby teaming. As illustrated in FIG. 30, this system includes switches 11 to 14, nodes 21 to 24, routers 31 and 32, external networks 41 and 42, and a server 50.

The switches 11 to 14 are layer 2 switches configuring a network to which NICs 51 and 52 are connected.

The nodes 21 to 24 are nodes in a same segment which are the communication counterparts of a virtual NIC 50a. Unique MAC (Media Access Control) addresses are assigned to the nodes 21 to 24. For example, MAC addresses assigned to the nodes 21, 22, 23, and 24 are given as N1, N2, N3, and N4, respectively.

The routers 31 and 32 are routers for relaying communication for the external networks 41 and 42. The routers 31 and 32 perform routing using TCP (Transmission Control Protocol)/IP (Internet Protocol). The routers 31 and 32 perform communication with a virtual NIC using MAC addresses. For example, MAC addresses assigned to the routers 31 and 32 are given as R1 and R2, respectively.

The external networks 41 and 42 are networks of different segments. An unspecified large number of nodes are present in the external networks 41 and 42, and the unspecified large number of nodes perform communication with the virtual NIC 50a using TCP/IP protocol or the like via the routers 31 and 32.

The server 50 includes the virtual NIC 50a, and the NICs 51 and 52. The virtual NIC 50a is a virtual NIC in which the NIC 51 and the NIC 52 are teamed. The virtual NIC 50a uses the NIC 51 or the NIC 52, and performs communication using Layer 2 protocol such as the Ethernet (registered trademark; same applies hereinafter).

The NICs 51 and 52 are physical NICs connected to the same network segment. The network segment corresponds to a broadcast domain.

In the case all of the NICs 51 and 52 and the switches 11 to 14 are normally operating, the virtual NIC 50a exclusively uses the NIC 51 or 52 to perform communication. For example, the virtual NIC 50a places the NIC 51 in an active state, and the NIC 52 in a standby state. Then, the virtual NIC 50a performs communication with all of the nodes 21 to 24 and the external networks 41 and 42 using the NIC 51, and keeps the NIC 52 in a wait state. Additionally, a virtual MAC address is assigned to the virtual NIC 50a.

Packets from the virtual NIC 50a to the nodes 21 to 24 are directly transmitted to the MAC addresses N1 to N4 of the respective nodes. Packets from the virtual NIC 50a to the external network 41 or 42 are transmitted to the MAC address R1 or R2 of the router according to routing information in the server 50, and are relayed to the destination network by the router.

Packets from the nodes 21 to 24 to the virtual NIC 50a are transmitted to the virtual MAC address. Packets from the external network 41 or 42 to the virtual NIC 50a are transmitted to the virtual MAC address via the router 31 or the router 32.

Next, a process of the system in FIG. 30 at the time of NIC breakdown will be described. FIG. 31 is a diagram for describing the process of the system in FIG. 30 at the time of NIC breakdown. In the upper part in FIG. 31, the NIC 51 is in the active state and the NIC 52 is in the standby state, as described with reference to FIG. 30. It is assumed that, in this state, an abnormality occurs in the NIC 51 or the switch 11 which is the connection destination, and that the NIC 51 is placed in a link-down state.

As illustrated in the lower part in FIG. 31, in the case the NIC 51 is placed in the link-down state, the virtual NIC 50a places the NIC 52 in the active state and performs switching to the NIC 52. The communication is maintained by the virtual NIC 50a performing switching to the NIC 52. The virtual NIC 50a performs communication to all of the nodes 21 to 24 and the external networks 41 and 42 using the NIC 52.

Next, an example of the load balancing teaming will be described. The load balancing teaming is a mode of teaming that uses a plurality of NICs connected to a single network segment at the same time. Also, in the case of performing one-to-many or many-to-many communication, the load balancing teaming balances the communication load by changing the NIC to be used for communication depending on the destination or the transmission source.

FIG. 32 is a system configuration diagram for describing the load balancing teaming. As illustrated in FIG. 32, this system includes switches 11 to 14, nodes 21 to 24, routers 31 and 32, external networks 41 and 42, and a server 60. As described below, in the case of performing NIC teaming in an environment where a plurality of virtual machines 60a and 60b are operated in one physical server, the communication load is balanced by using a different NIC for communication for each virtual machine.

Description of the switches 11 to 14, the nodes 21 to 24, the routers 31 and 32, and the external networks 41 and 42 is the same as the description of the switches 11 to 14, the nodes 21 to 24, the routers 31 and 32, and the external networks 41 and 42 illustrated in FIG. 30.

The server 60 includes NICs 51 and 52, a virtual NIC 50a, VMs (Virtual Machines) 60a and 60b, and a virtual bridge 60c. Description of the NICs 51 and 52, and the virtual NIC 50a is the same as the description of the NICs 51 and 52, and the virtual NIC 50a illustrated in FIG. 30.

The VMs 60a and 60b are virtual machines that operate on a hypervisor. For example, the VM 60a includes a VM-NIC 61a. The VM 60b includes a VM-NIC 61b. The VM-NIC 61a is a virtual NIC on the VM 60a, and is assigned with MAC address “MAC-VM1”. The VM-NIC 61b is a virtual NIC on the VM 60b, and is assigned with MAC address “MAC-VM2”.

The virtual bridge 60c is a virtual bridge for relaying communication between a virtual machine and a physical network. The virtual bridge 60c is connected to an external network via the virtual NIC 50a.

In the state where all of the NICs 51 and 52 and the switches 11 to 14 are normally operating, the virtual NIC 50a uses the NIC 51, of the redundant NICs 51 and 52, for the communication of VM 60a. Also, the NIC 52 is used for the communication of the VM 60b.

Next, a process of the system in FIG. 32 at the time of NIC breakdown will be described. Here, a case where an abnormality has occurred in the NIC 51 or the switch 11 which is a connection destination, and the NIC 51 is placed in a link-down state will be described, for example. In this case, the virtual NIC 50a maintains the communication by switching from the NIC 51 to the NIC 52, with respect to the communication of the VM 60a. Since the communication of all the VMs 60a and 60b is performed by the NIC 52, the communication load concentrates on the NIC 52, but both the VMs 60a and 60b are enabled to transmit packets to all the communication counterparts. These related-art examples are described, for example, in Japanese National Publication of International Patent Application No. 2009-508443, Japanese Laid-open Patent Publication No. 2003-8581 and Japanese Laid-open Patent Publication No. 2007-116751.

However, with the conventional technique described above, there is an issue that communication between a server and each node is not maintained.

An issue of the active/standby teaming will be described. FIG. 33 is a diagram for describing an issue of the active/standby teaming. For example, in the case an abnormality occurs in the link between a switch 12 and a switch 13, as illustrated in FIG. 33, a network will be divided into two. In this case, the NIC 51 is able to maintain communication to nodes 21 and 22, and an external network 41, but communication to nodes 23 and 24, and an external network 42 is interrupted. Also, if switching from an NIC 51 to an NIC 52 is performed, communication with the nodes 23 and 24, and the external network 42 will be enabled, but communication to the nodes 21 and 22, and the external network 41 will be interrupted.

That is, according to the active/standby teaming, communication cannot be maintained in the case a single network segment is divided into a plurality of segments due to breakdown of a switch or interruption of a link between switches.

An issue of the load balancing teaming will be described. FIG. 34 is a diagram for describing an issue of the load balancing teaming. For example, in the case an abnormality occurs in the link between a switch 12 and a switch 13, as illustrated in FIG. 34, a network will be divided into two. Accordingly, a VM 60a can maintain communication to nodes 21 and 22, and an external network 41, but cannot maintain communication to nodes 23 and 24, and an external network 42. Similarly, a VM 60b can maintain communication to the nodes 23 and 24, and the external network 42, but cannot maintain communication to the nodes 21 and 22, and the external network 41.

That is, according to the load balancing teaming, communication cannot be maintained in the case a single network segment is divided into a plurality of segments due to breakdown of a switch or interruption of a link between switches.

### SUMMARY

According to an aspect of an embodiment, a calculator includes a memory; and a processor coupled to the memory, wherein the processor executes a process comprising: detecting division of a network by communication with other communication devices, in the network, belonging to a same segment; generating information about a correspondence relationship between each of the other communication devices and an appliance in a respective reachable network, when the division is detected; and performing communication between a communication device and an appliance in a network based on the information about a correspondence relationship.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of a calculator according to a first embodiment;

FIG. 2 is a diagram for describing a configuration of a system according to a second embodiment;

FIG. 3 is a diagram illustrating an example of a data structure of a heartbeat message;

FIG. 4 is a diagram illustrating an example of a data structure of a MAC address table according to the second embodiment;

FIG. 5 is a diagram for describing a process of learning a correspondence relationship between a node and an NIC capable of reaching the node;

FIG. 6 is a diagram for describing a configuration of a system according to a third embodiment;

FIG. 7 is a diagram illustrating an example of a case where a network is divided into two, with respect to the third embodiment;

FIG. 8 is a flow chart illustrating a processing procedure of the system of the third embodiment for a case where the network is divided into two;

FIG. 9 is a diagram illustrating an example of a case where the network is divided into three, with respect to the third embodiment;

FIG. 10 is a flow chart (1) illustrating a processing procedure of the system of the third embodiment for a case where the network is divided into three;

FIG. 11 is a flow chart (2) illustrating a processing procedure of the system of the third embodiment for a case where the network is divided into three;

FIG. 12 is a diagram illustrating an example of a communication path which is to be monitored;

FIG. 13 is a diagram illustrating combinations of states of physical NICs;

FIG. 14 is a diagram (1) illustrating states of network topology monitoring;

FIG. 15 is a flow chart illustrating a processing procedure of a virtual NIC according to the third embodiment for determining a topology state of a network;

FIG. 16 is a diagram (2) illustrating states of network topology monitoring;

FIG. 17 is a diagram for describing a configuration of a system according to a fourth embodiment;

FIG. 18 is a diagram illustrating an example of the degree of priority of each NIC for each virtual machine;

FIG. 19 is a diagram for describing a process of a virtual NIC of the fourth embodiment for checking that a network is not divided;

FIG. 20 is a diagram (1) for describing a process of the virtual NIC of the fourth embodiment for identifying a divided part;

FIG. 21 is a diagram illustrating a reaching state of a heartbeat message where a network is divided into two as illustrated in FIG. 20;

FIG. 22 is a diagram (2) for describing a process of the virtual NIC of the fourth embodiment for identifying a divided part;

FIG. 23 is a diagram illustrating a reaching state of a heartbeat message where a network is divided into three as illustrated in FIG. 22;

FIG. 24 is a diagram illustrating an example of a data structure of a physical NIC monitoring table;

FIG. 25 is a diagram illustrating an example of a data structure of a path monitoring table;

FIG. 26 is a flow chart illustrating a processing procedure of the virtual NIC according to the fourth embodiment for determining a path state;

FIG. 27 is a flow chart illustrating a processing procedure for evaluating a result of a heartbeat message;

FIG. 28 is a flow chart illustrating a packet transmission procedure;

FIG. 29 is a diagram illustrating an example of a computer for executing a communication control program;

FIG. 30 is a system configuration diagram for describing active/standby teaming;

FIG. 31 is a diagram for describing a process of a system in FIG. 30 at the time of NIC breakdown;

FIG. 32 is a system configuration diagram for describing load balancing teaming;

FIG. 33 is a diagram for describing an issue of the active/standby teaming; and

FIG. 34 is a diagram for describing an issue of the load balancing teaming.

### DESCRIPTION OF EMBODIMENTS

Preferred embodiments of the present invention will be explained with reference to accompanying drawings. Additionally, the present invention is not limited by the embodiments.

### [a] First Embodiment

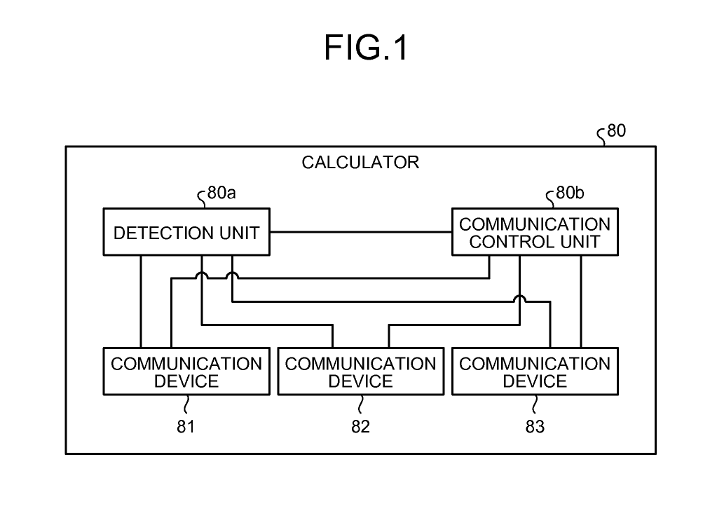

A configuration of a calculator according to a first embodiment will be described. FIG. 1 is a functional block diagram illustrating a configuration of the calculator according to the first embodiment. As illustrated in FIG. 1, this calculator 80 includes communication devices 81, 82, and 83, a detection unit 80a, and a communication control unit 80b. The calculator 80 may include communication devices other than the communication devices 81 to 83.

The detection unit 80a performs communication between other communication devices 81, 82, and 83, in a network, belonging to the same segment, to thereby detect division of a network connected to each of the communication devices 81, 82, and 83.

In the case division is detected, the communication control unit 80b generates information about a correspondence relationship between the other communication appliance and an appliance in a reachable network. The communication control unit 80b performs communication between the communication device 81, 82, or 83 and the appliance in the network based on the information about the correspondence relationship.

Next, an effect of the calculator 80 according to the first embodiment will be described. The calculator 80 according to the first embodiment performs communication using a communication device that is capable of reaching an appliance in the network, in the case division of the network connected to the communication devices 81 to 83 is detected. Accordingly, even if a network is divided due to breakdown of a network unit, there will be no appliance that the calculator 80 is not able to connect to.

### [b] Second Embodiment

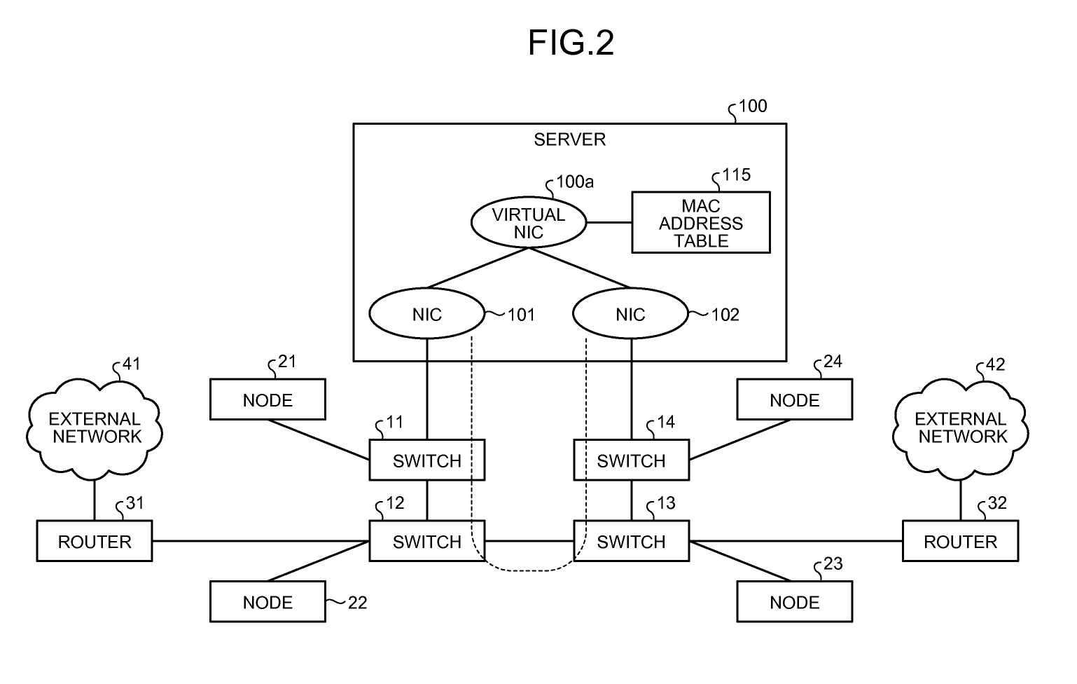

Next, a configuration of a system according to a second embodiment will be described. FIG. 2 is a diagram for describing a configuration of the system according to the second embodiment. As illustrated in FIG. 2, this system includes switches 11 to 14, nodes 21 to 24, routers 31 and 32, external networks 41 and 42, and a server 100.

The switches 11 to 14 are layer 2 switches configuring a network to which NICs 101 and 102 are connected.

The routers 31 and 32 are routers for relaying communication for the external networks 41 and 42. The routers 31 and 32 perform routing using TCP/IP protocol. The routers 31 and 32 perform communication with a virtual NIC 100a using MAC addresses. For example, MAC addresses assigned to the routers 31 and 32 are given as R1 and R2, respectively.

The external networks 41 and 42 are networks of different segments. An unspecified large number of nodes are present in the networks 41 and 42, and the unspecified large number of nodes perform communication with the virtual NIC 100a using TCP/IP protocol or the like via the routers 31 and 32.

The server 100 includes the virtual NIC 100a, the NICs 101 and 102, and a MAC address table 115. The NICs 101 and 102 are physical NICs connected to the same network segment. The network segment corresponds to a broadcast domain. Also, the NICs 101 and 102 are assumed to belong to the same team.

The virtual NIC 100a is a virtual NIC in which the NICs 101 and 102 are teamed, and performs control regarding transmission/reception of heartbeat messages. The virtual NIC 100a corresponds to a detection unit and a communication control unit, for example. The virtual NIC 100a exchanges heartbeat messages between the NICs 101 and 102 that are teamed to thereby monitor the state of the network topology, and detects whether the network is divided. Then, the virtual NIC 100a controls communication between the NICs 101 and 102 and respective nodes, based on whether the network is divided.

An example of a process of the virtual NIC 100a for detecting division of the network will be described. The virtual NIC 100a transmits a heartbeat message from the NIC 101 to the NIC 102, and in the case the NIC 102 receives the heartbeat message from the NIC 101 within a predetermined period of time, the virtual NIC 100a determines that the network is not divided. On the other hand, in the case the NIC 102 does not receive the heartbeat message from the NIC 101 within the predetermined period of time after the NIC 101 has transmitted the heartbeat message to the NIC 102, the virtual NIC 100a determines that the network is divided.

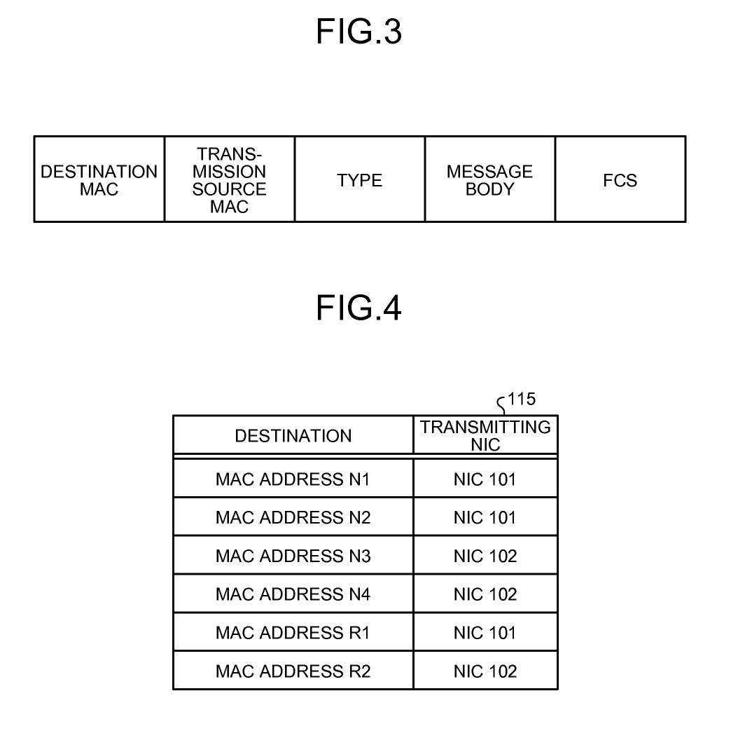

FIG. 3 is a diagram illustrating an example of a data structure of the heartbeat message. As illustrated in FIG. 3, the heartbeat message includes a destination MAC, a transmission source MAC, a type, a message body, and an FCS (Frame Check Sequence).

The MAC address of a destination NIC is set in the destination MAC. Additionally, in the case of collectively transmitting a heartbeat message to a plurality of NICs, it is possible to set a broadcast address or a multicast address in the destination MAC.

The address of a transmission source NIC is specified in the transmission source MAC. An arbitrary value is set in the type. Arbitrary information, such as the type of a message, a time stamp, a sequence number or the like, is set in the message body. Information to be used for error detection with respect to the heartbeat message is stored in the FCS.

For example, in the case of the virtual NIC 100a transmitting a heartbeat message from the NIC 101 to the NIC 102, the MAC address of the NIC 102 is set in the destination MAC, and the MAC address of the NIC 101 is set in the transmission source MAC.

Additionally, the virtual NIC 100a may determine whether the network is divided, by transmitting a heartbeat message from the NIC 102 to the NIC 101.

Next, a process of the virtual NIC 100a in a case the network is not divided will be described. The virtual NIC 100a performs communication using one of the teamed NICs 101 and 102. For example, the virtual NIC 100a performs communication in the same manner as the active/standby teaming or the load balancing teaming. In the case the NIC 101 or the NIC 102 breaks down, the virtual NIC 100a performs degraded operation.

Next, a process of the virtual NIC 100a in a case the network is divided will be described. For example, in a case an abnormality occurs in the link between a switch 12 and a switch 13, heartbeat between the NIC 101 and the NIC 102 is interrupted, and the virtual NIC 100a may thus detect that the network is divided into two. When the network is divided, the NIC 101 can maintain communication to nodes 21 and 22, and an external network 41, but communication to nodes 23 and 24, and an external network 42 is interrupted. Also, if switching from the NIC 101 to the NIC 102 is performed, communication to the nodes 23 and 24, and the external network 42 may be performed, but communication to the nodes 21 and 22, and the external network 42 is interrupted.

Accordingly, the virtual NIC 100a maintains the communication to the nodes 21 to 24, and the external networks 41 and 42 by placing the NIC 101 and the NIC 102 in the active state. Additionally, the virtual NIC 100a continues to transmit/receive heartbeat messages, and detects recovery of the link between the switches 12 and 13.

The virtual NIC 100a transmits, from both the NIC 101 and the NIC 102, a packet from the application of the server 100 to a communication counterpart, immediately after placing the NIC 101 and the NIC 102 in the active state. The virtual NIC 100a duplicates the packet, and transmits the packets from the NICs 101 and 102 at the same time. Alternatively, the virtual NIC 100a may transmit the packet by alternately using the NICs 101 and 102 in a round-robin manner.

After transmitting the packet, the virtual NIC 100a receives a response packet for the packet from the network, and registers the transmission source MAC address of the response packet and information about the NIC which has received the response packet in the MAC address table 115 in association with each other. The virtual NIC 100a causes the correspondence relationship between a node and an NIC capable of reaching the node to be learned in the MAC address table 115 by repeatedly performing the process.

FIG. 4 is a diagram illustrating an example of a data structure of the MAC address table according to the second embodiment. As illustrated in FIG. 4, this MAC address table 115 stores a destination and a transmitting NIC in association with each other. The destination corresponds to the MAC address of the node which is the transmission source of the response packet. The transmitting NIC corresponds to the NIC which has received the response packet. For example, at the top in FIG. 4, it is indicated that a response packet transmitted from the node 21 whose MAC address is “N1” is received by the NIC 101. Accordingly, if a packet is transmitted from the NIC 101, this packet will reach the node 21.

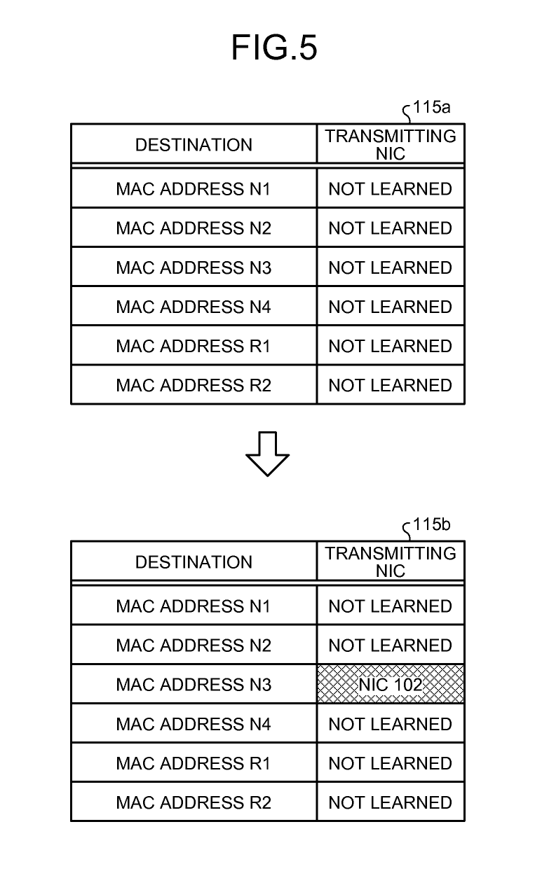

Now, an example of the process of the virtual NIC 100a for causing the correspondence relationship between a node and an NIC capable of reaching the node to be learned in the MAC address table 115 will be described. FIG. 5 is a diagram for describing a process of learning the correspondence relationship between a node and an NIC capable of reaching the node. A MAC address table 115a in FIG. 5 corresponds to an initial state of the MAC address table. Accordingly, the transmitting NICs in the MAC address table 115a are all not yet learned.

For example, a case will be described where the virtual NIC 100a receives, from the application, a transmission request for a packet destined for the node 23. Additionally, it is assumed that there is an abnormality in the link between the switch 12 and the switch 13. The virtual NIC duplicates the packet, and transmits the packet destined for the node 23 from the NIC 101 and the NIC 102. Since the node 23 does not exist in the network which is the transmission destination of the NIC 101, the packet destined for the node 23 transmitted from the NIC 101 is discarded.

On the other hand, the node 23 exists in the network which is the transmission destination of the NIC 102, and thus, the packet destined for the node 23 transmitted from the NIC 102 reaches the node 23. The node 23 transmits a response packet destined for the virtual NIC 100a. The virtual NIC 100a receives the response packet from the node 23 via the NIC 102. At this time, the virtual NIC 100a registers MAC address “N3” of the node 23 and the NIC 102 in a MAC address table 115b in association with each other. The virtual NIC 100a uses the NIC 102 in the case of transmitting a packet destined for the node 23, based on the learning result.

The virtual NIC 100a similarly learns the NIC which has received a response packet from a node or a router with respect to other nodes and external networks. For example, the information illustrated in FIG. 4 is registered in the MAC address table 115 at the end. The virtual NIC 100a performs communication to the nodes 21 and 22, and the external network 41 by using the NIC 101. The virtual NIC 100a performs communication to the nodes 23 and 24, and the external network 42 by using the NIC 102. Also, in the case a packet for which a broadcast address or a multicast address, the virtual NIC 100a transmits the packet by using the NICs 101, 102 so that reception by all the clients is enabled.

Next, a process of the virtual NIC 100a at the time of breakdown of a switch will be described. For example, it is assumed that the switch 13 has broken down. When the switch 13 breaks down, communication between the switch 12 and the switch 13 is disabled, and thus, the network is divided. Accordingly, the NIC 101 may maintain the communication to the nodes 21 and 22, and the external network 41, but communication to the nodes 23 and 24, and the external network 42 is interrupted.

In this case, the virtual NIC 100a may maintain communication to the nodes 21, 22, and 24, and the external network 41 by placing the NIC 101 and the NIC 102 in the active state, as in the case described above where the network is divided. However, in the case the switch 13 itself is broken down, communication to the node 23 and the external network 42 is interrupted because there is no physical path by which the node 23 and the external network 42 may be reached.

Next, a process of the virtual NIC 100a in the case the switch is recovered from breakdown will be described. Additionally, it is assumed that the NICs 101 and 102 are in the active state due to the breakdown of the switch. In the case division of the network is resolved by the maintenance work such as replacement of the switch which has broken down, transmission/reception of heartbeat messages between the NIC 101 and the NIC 102 becomes possible, and thus, the virtual NIC 100a determines that division of the network is resolved. The virtual NIC 100a causes the NIC 102 to return to the standby state, and performs communication to the nodes 21 to 24, and the external networks 41 and 42 by using only the NIC 101.

In the case division of the network is resolved, the virtual NIC 100a transmits a broadcast packet whose transmission source is a virtual MAC address from the NIC 101. The MAC address table of each of the switches 11 to 14 is thereby updated, and a packet destined for the virtual MAC address is transferred to the NIC 101.

After division of the network is resolved, the virtual NIC 100a causes the NIC 102 to return to the standby state, and performs communication to the nodes 21 to 24, and the external networks 41 and 42 by using only the NIC 101. The virtual NIC 100a may thereby avoid redundant learning of MAC address for a plurality of ports (MAC address flapping) on each of the switches 11 to 14, and may prevent communication from becoming unstable. Also, redundant reception of packets at the nodes 21 to 24 due to both of the NIC 101 and the NIC 102 continuously transmitting packets destined for a broadcast address or a multicast address may be avoided.

Next, an effect of the system depicted in the second embodiment will be described. The virtual NIC 100a detects division of the network by transmitting/receiving heartbeat messages between the NIC 101 and the NIC 102. In the case division of the network is detected, the virtual NIC 100a performs communication with a node by using both of the NIC 101 and the NIC 102. Accordingly, communication between the server 100 and each node may be maintained even if a single network segment is divided into a plurality of segments due to switch breakdown or interruption of a link between switches.

Also, in the case division of the network is detected, the virtual NIC 100a registers a relationship between each physical NIC and a node in a reachable network in the MAC address table 115. The virtual NIC 100a associates a physical NIC capable of reaching a connection destination and a node based on the MAC address table 115, and performs communication between the physical NIC and a node in the network. Accordingly, even if a single network segment is divided into a plurality of segments due to switch breakdown or interruption of a link between switches, communication to each node may be maintained without increasing the amount of traffic or the like.

### [c] Third Embodiment

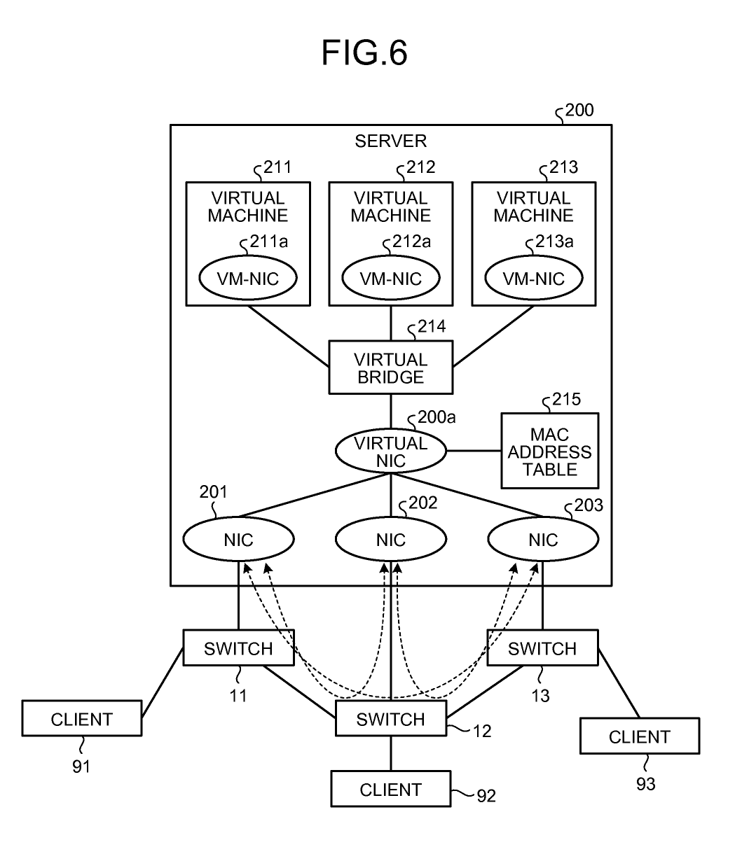

Now, a configuration of a system according to a third embodiment will be described. FIG. 6 is a diagram for describing a configuration of the system according to the third embodiment. As illustrated in FIG. 6, this system includes switches 11 to 13, clients 91 to 93, and a server 200.

The switches 11 to 13 are layer 2 switches configuring a physical network, and relay the communication between the server 200 and respective clients 91 to 93.

The clients 91 to 93 are clients to be the communication counterparts of virtual machines 211 to 213. MAC addresses of the clients 91 to 93 are given as MAC-C1, MAC-C2, and MAC-C3, respectively.

The server 200 is a physical server where the hypervisor for executing the virtual machines 211 to 213 operates. The server 200 includes a virtual NIC 200a, NICs 201 to 203, the virtual machines 211 to 213, a virtual bridge 214, and a MAC address table 215.

The virtual NIC 200a is a virtual NIC teaming the NICs 201 to 203. The NICs 201 to 203 are physical NICs installed on the server 200. MAC addresses of the NICs 201, 202, and 203 are given as MAC-1, MAC-2, and MAC-3, respectively. The NICs 201 to 203 are expressed as the physical NIC(s) as appropriate.

The virtual machines 211 to 213 are virtual machines operating on the hypervisor. The virtual machines 211 to 213 include VM-NICs 211a to 213a, respectively.

The VM-NIC 211a is a virtual NIC on the virtual machine 211. MAC address “MAC-VM1” is set for the VM-NIC 211a. The VM-NIC 211a performs communication using Layer 2 protocol such as the Ethernet by using the NICs 201 to 203.

The VM-NIC 212a is a virtual NIC on the virtual machine 212. MAC address “MAC-VM2” is set for the VM-NIC 212a. The VM-NIC 212a performs communication using Layer 2 protocol such as the Ethernet by using the NICs 201 to 203.

The VM-NIC 213a is a virtual NIC on the virtual machine 213. MAC address “MAC-VM3” is set for the VM-NIC 213a. The VM-NIC 213a performs communication using Layer 2 protocol such as the Ethernet by using the NICs 201 to 203.

The virtual bridge 214 is a virtual bridge for relaying communication between the virtual machines 211 to 213 and the physical network. The virtual bridge 214 is connected to an external network via the virtual NIC 200a.

Next, the virtual NIC 200a will be concretely described. The virtual NIC 200a has the function of monitoring the network topology, and the function of monitoring the link state of the NICs 201, 202, and 203. Also, the virtual NIC 200a has the function of performing load balancing by a transmission source MAC address or of following a destination MAC address.

First, the function of monitoring the network topology will be described. The virtual NIC 200a transmits heartbeat messages among the NICs 201 to 203, and monitors the state of the communication paths among the NICs 201 to 203. The data structure of the heartbeat message is the same as the data structure illustrated in FIG. 3.

The communication paths to be monitored by the virtual NIC 200a are those between the NIC 201 and the NIC 202, the NIC 202 and the NIC 203, and the NIC 203 and the NIC 201. If the heartbeat is interrupted in any of the communication paths, the virtual NIC 200a determines that the network is divided. If the interruption of the heartbeat is resolved, it is determined that division of the network is resolved.

Next, the function of the virtual NIC 200a for monitoring the link state of the NICs 201, 202, and 203 will be described. The virtual NIC 200a monitors the link state of the NICs 201, 202, and 203. In the case a link down due to a breakdown of any of the NICs or of a connection destination switch is detected, the virtual NIC 200a cuts off the NIC where the link down has occurred, and performs communication by degraded operation.

Next, the function of performing load balancing by a transmission source MAC address or of following a destination MAC address will be described. If, according to the monitoring of the network topology, all the heartbeats are conveyed, the virtual NIC 200a performs communication with an external network in the following manner by using a physical NIC different for each virtual machine.

For example, the NIC 201 is used for the communication of the virtual machine 211. The NIC 202 is used for the communication of the virtual machine 212. The NIC 203 is used for the communication of the virtual machine 213.

On the other hand, in the case some or all of the heartbeats are interrupted, the virtual NIC 200a performs communication by using a physical NIC different for each communication counterpart. For example, if all the heartbeats are interrupted, communication is performed in the following manner by using a physical NIC different for each communication counterpart.

For example, the NIC 201 is used for the communication to the client 91. The NIC 202 is used for the communication to the client 92. The NIC 203 is used for the communication to the client 93.

Next, the monitoring state of the network topology and an example of the physical NIC to be used by each virtual machine for each client in a state where the system of the third embodiment is normally operating will be described.

The monitoring state of the network topology is as below. Heartbeat messages are conveyed between the NIC 201 and the NIC 202. Heartbeat messages are conveyed between the NIC 202 and the NIC 203. Heartbeat messages are conveyed between the NIC 201 and the NIC 203. In this case, the virtual NIC 200a determines that the system is normally operating.

A physical NIC to be used by each virtual machine for each client is as below. The virtual NIC 200a performs communication between the virtual machine 211 and the clients 91 to 93 by using the NIC 201. The virtual NIC 200a performs communication between the virtual machine 212 and the clients 91 to 93 by using the NIC 202. The virtual NIC 200a performs communication between the virtual machine 213 and the clients 91 to 93 by using the NIC 203. In this manner, the virtual NIC 200a performs load balancing by performing communication of each virtual machine while selecting a different physical NIC.

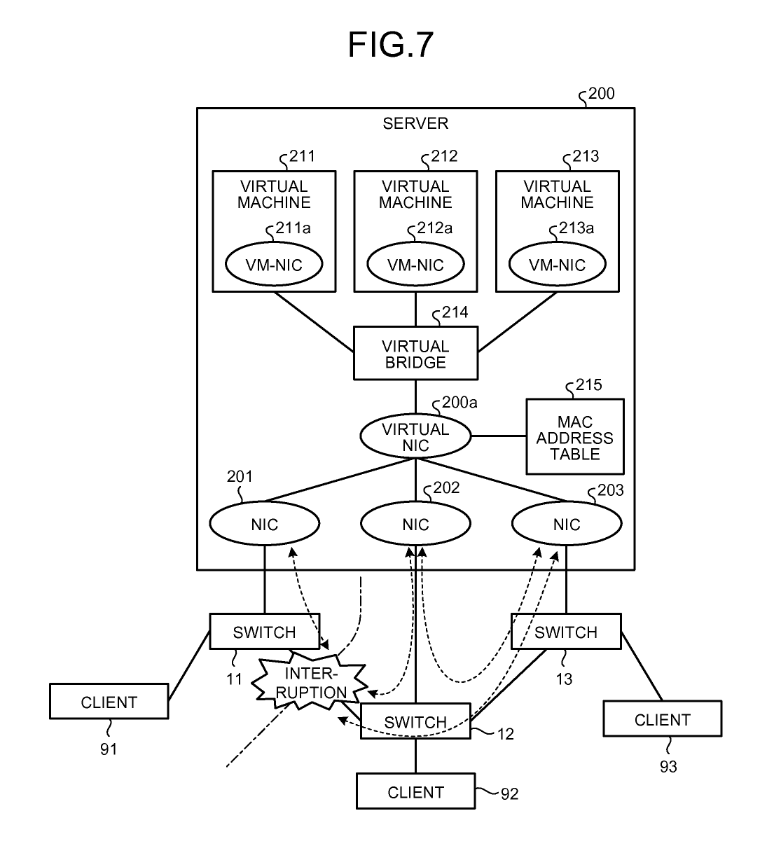

Next, the monitoring state of the network topology and an example of the physical NIC to be used by each virtual machine for each client in a state where the system is divided into two will be described. FIG. 7 is a diagram illustrating an example of a case where the network is divided into two, with respect to the third embodiment. As illustrated in FIG. 7, it is assumed that the connection between the switch 11 and the switch 12 is interrupted, for example.

As illustrated in FIG. 7, in the case the network is divided, the monitoring state of the network topology will be as below. That is, heartbeat messages are interrupted between the NIC 201 and the NIC 202. Heartbeat messages are conveyed between the NIC 202 and the NIC 203. Heartbeat messages are interrupted between the NIC 201 and the NIC 203. In this case, the virtual NIC 200a determines that the network is divided into a network including the switch 11 and the client 91, and a network including the switches 12 and 13, and the clients 92 and 93.

In the case the network is divided as illustrated in FIG. 7, the physical NIC to be used by each virtual machine for each client will be as below. That is, the virtual NIC 200a performs communication between the virtual machine 211 and the client 91 by using the NIC 201. The virtual NIC 200a performs communication between the virtual machine 211 and the clients 92 and 93 by using the NIC 202.

The virtual NIC 200a performs communication between the virtual machine 212 and the client 91 by using the NIC 201. The virtual NIC 200a performs communication between the virtual machine 212 and the clients 92 and 93 by using the NIC 202.

The virtual NIC 200a performs communication between the virtual machine 213 and the client 91 by using the NIC 201. The virtual NIC 200a performs communication between the virtual machine 213 and the clients 92 and 93 by using the NIC 203.

As described above, communication of each of the virtual machines 211 to 213 is relayed by a physical NIC different for each communication counterpart by following the MAC address of the communication counterpart.

Communication of a virtual machine in a case where the network is divided as illustrated in FIG. 7 will be described. Here, communication of the virtual machine 211 will be described as an example.

Before the network is divided, since all the clients 91 to 93 may be reached by the NIC 201, communication of the virtual machine 211 is performed by using only the NIC 201. The NICs 202 and 203 are in a wait state. When the connection between the switch 11 and the switch 12 is interrupted as illustrated in FIG. 7, packets transmitted by the NIC 201 may reach only the client 91, and not the clients 92 and 93.

In the case the network is divided as illustrated in FIG. 7, if one of the NICs 202 and 203 in the wait state is additionally used for communication, the virtual machine 211 may perform communication with the clients 91 to 93. The virtual NIC 200a registers, in the MAC address table 215, with respect to each client of the communication counterpart, which NIC is capable of reaching the client. The virtual NIC 200a transmits packets from the NICs 201 and 202. The virtual NIC 200a receives a response packet for such a packet from the network, and registers the transmission source MAC address of the response packet and information about the NIC which has received the response packet in the MAC address table 215 in association with each other.

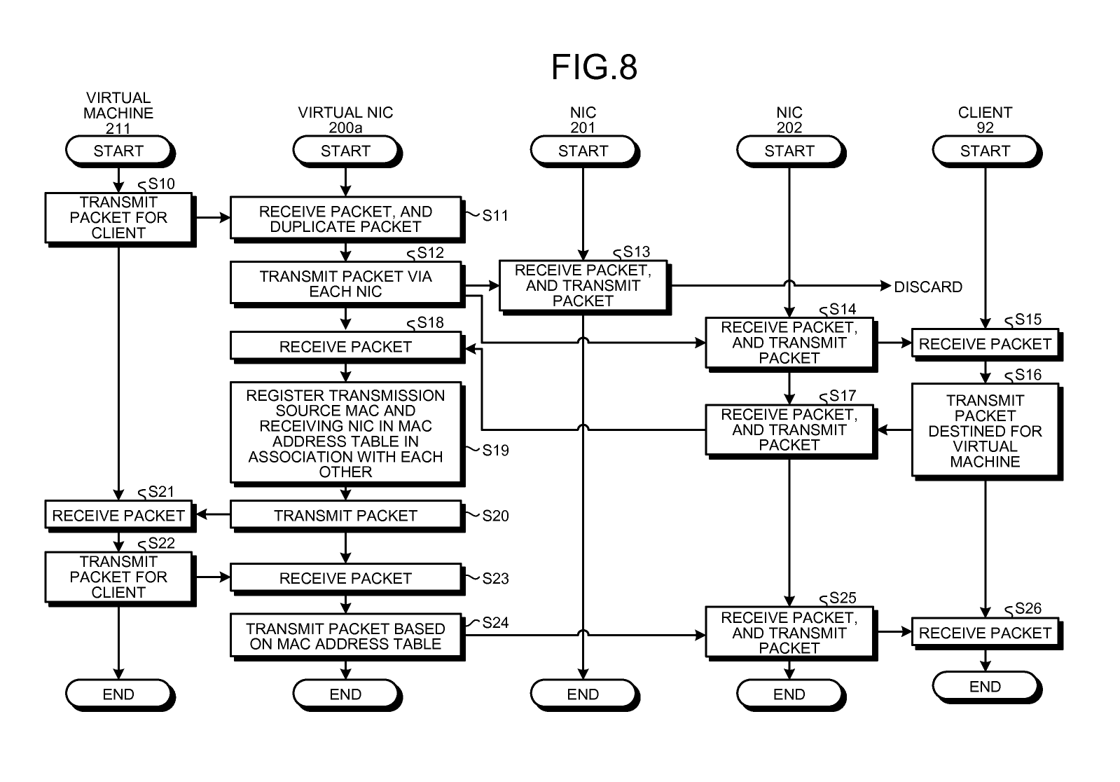

FIG. 8 is a flow chart illustrating a processing procedure of the system of the third embodiment for a case where the network is divided into two. The example illustrated in FIG. 8 illustrates communication between the virtual machine 211 and the client 92. The virtual machine 211 transmits a packet to the client 92 (step S10). The virtual NIC 200a receives the packet, and duplicates the packet (step S11).

The virtual NIC 200a transmits the packets via the NICs 201 and 202 (step S12). The NIC 201 receives the packet, and transmits the packet (step S13). As illustrated in FIG. 7, since the client 92 is not present in the network connected to the NIC 201, the packet is discarded.

The NIC 202 receives the packet, and transmits the packet (step S14). As illustrated in FIG. 7, the client 92 is present in the network connected to the NIC 202. Accordingly, the client 92 receives the packet (step S15), and transmits the packet for the virtual machine 211 (step S16).

The NIC 202 receives the packet, and transmits the packet to the virtual NIC 200a (step S17). The virtual NIC 200a receives the packet (step S18). The virtual NIC 200a registers the transmission source MAC and the receiving NIC in the MAC address table 215 in association with each other (step S19). The virtual NIC 200a registers, in step S19, MAC address “MAC-C2” of the client 92 and the NIC 202 in the MAC address table 215 in association with each other.

The virtual NIC 200a transmits the packet to the virtual machine 211 (step S20), and the virtual machine 211 receives the packet (step S21).

The virtual machine 211 transmits the packet destined for the client 92 (step S22). The virtual NIC 200a receives the packet (step S23), and transmits the packet to the NIC 202 based on the MAC address table 215 (step S24).

The NIC 202 receives the packet, and transmits the packet (step S25). The client 92 receives the packet (step S26). Although omitted from FIG. 8, the client 92 may transmit a packet for the virtual machine 211 after step S26.

As described with reference to FIG. 8, in the case an NIC capable of reaching the client 92 is not learned, the virtual NIC 200a transmits packets to the NICs 201 and 202, and waits for a packet from the client 92. Then, after the NIC capable of reaching the client 92 is learned in step S19, the virtual NIC 200a transmits a packet destined for the client 92 by using the NIC 202.

Similarly, with respect to the client 91, a packet will be transmitted by using the NIC 201. With respect to the client 93, a packet will be transmitted by using the NIC 202. Moreover, in the case a packet for which a broadcast address or a multicast address is set is acquired from the virtual machine 211, the virtual NIC 200a transmits the packet by using the NICs 201 and 202 so that reception by all the clients is enabled.

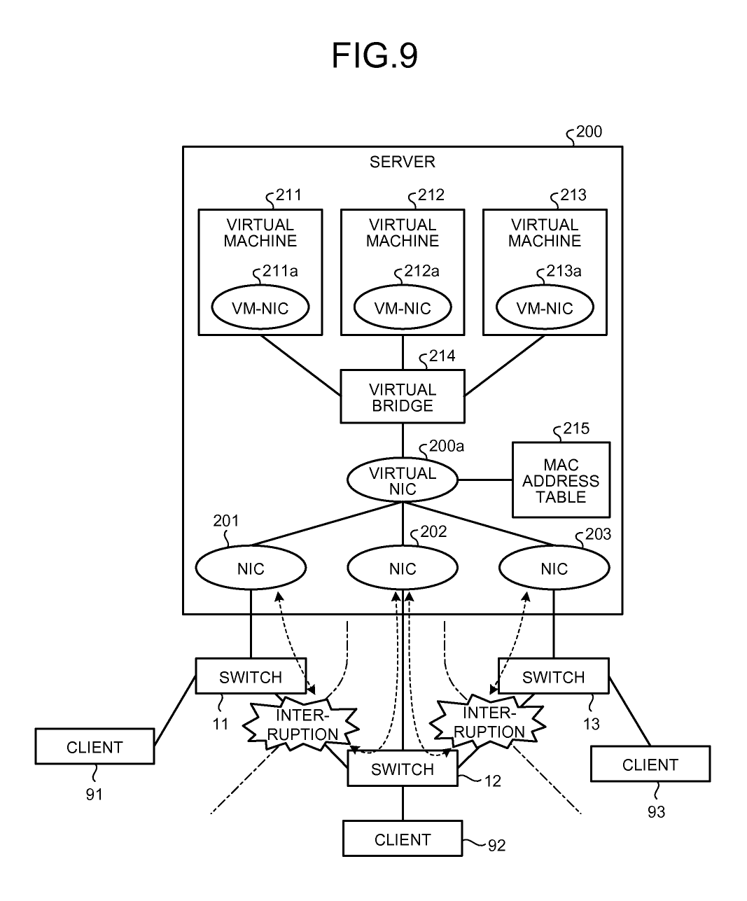

Next, the monitoring state of the network topology and an example of the physical NIC to be used by each virtual machine for each client in a state where the system is divided into three will be described. FIG. 9 is a diagram illustrating an example of a case where the network is divided into three, with respect to the third embodiment. As illustrated in FIG. 9, it is assumed that the connection between the switch 11 and the switch 12 is interrupted, and also, the connection between the switch 12 and the switch 13 is interrupted, for example.

As illustrated in FIG. 9, in the case the network is divided, the monitoring state of the network topology will be as below. That is, heartbeat messages are interrupted between the NIC 201 and the NIC 202. Heartbeat messages are interrupted between the NIC 202 and the NIC 203. Heartbeat messages are interrupted between the NIC 201 and the NIC 203. In this case, the virtual NIC 200a determines that the network is divided into a network including the switch 11 and the client 91, a network including the switch 12 and the client 92, and a network including the switch 13 and the client 93.

In the case the network is divided as illustrated in FIG. 9, the physical NIC to be used by each virtual machine for each client will be as below. That is, the virtual NIC 200a performs communication between the virtual machine 211 and the client 91 by using the NIC 201. The virtual NIC 200a performs communication between the virtual machine 211 and the client 92 by using the NIC 202. The virtual NIC 200a performs communication between the virtual machine 211 and the client 93 by using the NIC 203.

The virtual NIC 200a performs communication between the virtual machine 212 and the client 91 by using the NIC 201. The virtual NIC 200a performs communication between the virtual machine 212 and the client 92 by using the NIC 202. The virtual NIC 200a performs communication between the virtual machine 212 and the client 93 by using the NIC 203.

The virtual NIC 200a performs communication between the virtual machine 213 and the client 91 by using the NIC 201. The virtual NIC 200a performs communication between the virtual machine 213 and the client 92 by using the NIC 202. The virtual NIC 200a performs communication between the virtual machine 213 and the client 93 by using the NIC 203.

Communication of a virtual machine in a case where the network is divided as illustrated in FIG. 9 will be described. Here, communication of the virtual machine 211 will be described as an example.

Before the network is divided, since all the clients 91 to 93 may be reached by the NIC 201, communication of the virtual machine 211 is performed by using only the NIC 201. The NICs 202 and 203 are in the wait state. When the connection between the switches 11 and 12 and the connection between the switches 12 and 13 are interrupted as illustrated in FIG. 9, packets transmitted by the NIC 201 may reach only the client 91, and not the clients 92 and 93. Also, packets transmitted by the NIC 202 may reach only the client 92, and not the clients 91 and 93. Moreover, packets transmitted by the NIC 203 may reach only the client 93, and not the clients 91 and 92.

Also, even if the network is divided into two, as illustrated in FIG. 7, and the process illustrated in FIG. 8 is performed, and the NIC 201 and the NIC 202 are used by the virtual machine 211 for communication, the virtual machine 211 is not able to perform communication with the client 93.

In the case the network is divided as illustrated in FIG. 9, if the NICs 201, 202, and 203 are used for communication, the virtual machine 211 may perform communication with the clients 91 to 93. The virtual NIC 200a registers, in the MAC address table 215, with respect to each client of the communication counterpart, which NIC is capable of reaching the client. The virtual NIC 200a transmits packets from the NICs 201 to 203. The virtual NIC 200a receives a response packet for such a packet from the network, and registers the transmission source MAC address of the response packet and information about the NIC which has received the response packet in the MAC address table 215 in association with each other. Additionally, if the information is already registered in the MAC address table 215 in a case where the network is divided into two, the virtual NIC 200a clears the MAC address table 215, and performs the learning again.

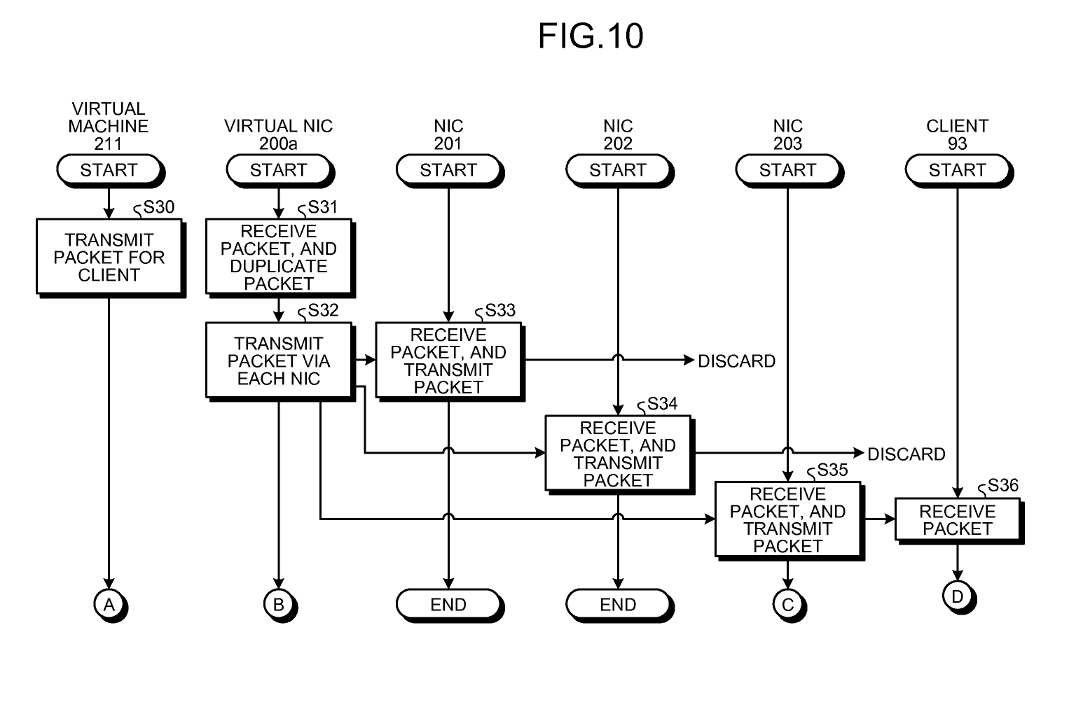

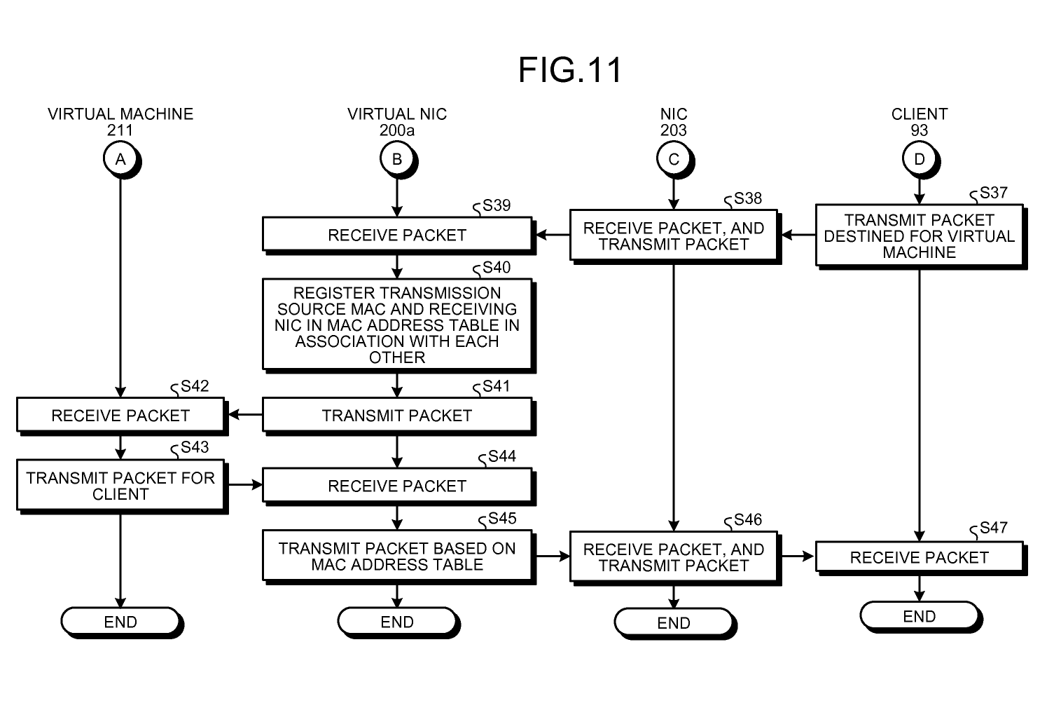

FIGS. 10 and 11 are flow charts illustrating a processing procedure of the system of the third embodiment for a case where the network is divided into three. Examples illustrated in FIGS. 10 and 11 illustrate communication between the virtual machine 211 and the client 93. As illustrated in FIG. 10, the virtual machine 211 transmits a packet for the client 93 (step S30). The virtual NIC 200a receives the packet, and duplicates the packet (step S31).

The virtual NIC 200a transmits the packets via the NICs 201, 202, and 203 (step S32). The NIC 201 receives the packet, and transmits the packet (step S33). As illustrated in FIG. 9, since the client 93 is not present in the network connected to the NIC 201, the packet is discarded.

The NIC 202 receives the packet, and transmits the packet (step S34). As illustrated in FIG. 9, since the client 93 is not present in the network connected to the NIC 202, the packet is discarded.

The NIC 203 receives the packet, and transmits the packet (step S35). As illustrated in FIG. 9, the client 93 is present in the network connected to the NIC 203. Accordingly, the client 93 receives the packet (step S36), and proceeds to step S37 in FIG. 11.

FIG. 11 will now be described. As illustrated in FIG. 11, the client 93 transmits the packet for the virtual machine 211 (step S37). The NIC 203 receives the packet, and transmits the packet (step S38). The virtual NIC 200a receives the packet (step S39). The virtual NIC 200a registers the transmission source MAC and the receiving NIC in the MAC address table 215 in association with each other (step S40). The virtual NIC 200a registers, in step S40, MAC address “MAC-C3” of the client 93 and the NIC 203 in the MAC address table 215 in association with each other.

The virtual NIC 200a transmits the packet to the virtual machine 211 (step S41), and the virtual machine 211 receives the packet (step S42).

The virtual machine 211 transmits the packet destined for the client 93 (step S43). The virtual NIC 200a receives the packet (step S44), and transmits the packet to the NIC 203 based on the MAC address table 215 (step S45).

The NIC 203 receives the packet, and transmits the packet (step S46). The client 93 receives the packet (step S47). Although omitted from FIG. 11, the client 93 may transmit a packet for the virtual machine 211 after step S47.

As described with reference to FIGS. 10 and 11, in the case an NIC capable of reaching the client 93 is not learned, the virtual NIC 200a transmits packets to the NICs 201 to 203, and waits for a packet from the client 93. Then, after the physical NIC capable of reaching the client 93 is learned in step S40, the virtual NIC 200a transmits packets destined for the client 93 by using the NIC 203.

Also, in the case a packet for which a broadcast address or a multicast address is set is acquired from the virtual machine 211, the virtual NIC 200a transmits the packet by using the NICs 201, 202, and 203 so that reception by all the clients is enabled.

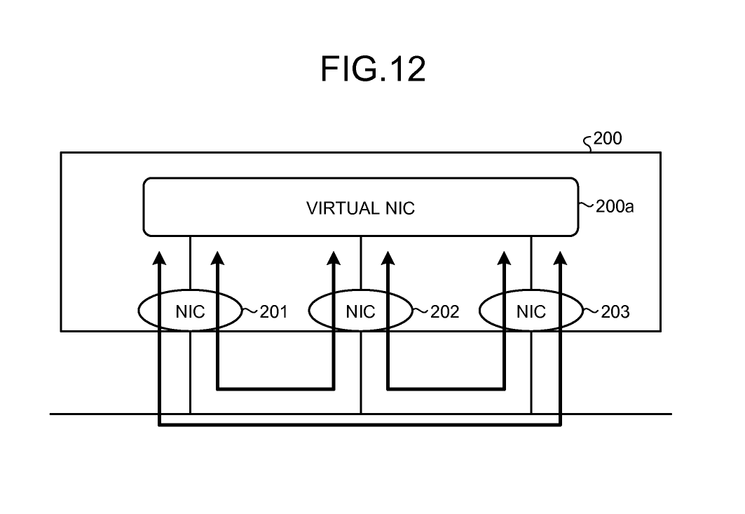

Next, the process of the virtual NIC 200a for monitoring the network topology and determining presence or absence of division will be described in greater detail. FIG. 12 is a diagram illustrating an example of a communication path which is to be monitored. The virtual NIC 200a monitors each communication path by transmitting a heartbeat message from each physical NIC to another physical NIC. Additionally, the data structure of the heartbeat message is the same as that illustrated in FIG. 3. MAC addresses of the NICs 201, 202, and 203 are given as MAC-1, MAC-2, and MAC-3.

The path for exchanging the heartbeat messages, the destination MAC address, and the transmission source MAC address are as below. Destination MAC address “MAC-2” and transmission source MAC address “MAC-1” are set in the heartbeat message for the “path from the NIC 201 to the NIC 202”. Destination MAC address “MAC-3” and transmission source MAC address “MAC-2” are set in the heartbeat message for the “path from the NIC 202 to the NIC 203”. Destination MAC address “MAC-1” and transmission source MAC address “MAC-3” are set in the heartbeat message for the “path from the NIC 203 to the NIC 201”.

Also, destination MAC address “MAC-1” and transmission source MAC address “MAC-2” are set in the heartbeat message for the “path from the NIC 202 to the NIC 201”. Destination MAC address “MAC-2” and transmission source MAC address “MAC-3” are set in the heartbeat message for the “path from the NIC 203 to the NIC 202”. Destination MAC address “MAC-3” and transmission source MAC address “MAC-1” are set in the heartbeat message for the “path from the NIC 201 to the NIC 203”.

For example, with respect to the path between the NIC 201 and the NIC 202, the virtual NIC 200a regularly transmits heartbeat messages destined for the NIC 202 from the NIC 201, and heartbeat messages destined for the NIC 201 from the NIC 202. In the case at least one of the heartbeat messages reaches a destination NIC, the virtual NIC 200a assumes that the communication path between the NIC 201 and the NIC 202 is normal.

On the other hand, if all the heartbeat messages fail to reach the destination NICs due to a breakdown of the switch or the like, the virtual NIC 200a determines that an abnormality has occurred in the communication path between the NIC 201 and the NIC 202. In this case, the virtual NIC 200a determines that the network topology is possibly divided.

After detecting an abnormality in the communication path, the virtual NIC 200a continues to transmit the heartbeat messages so as to detect recovery of the network. When at least one of the heartbeat messages reaches a destination NIC due to replacement of the broken down appliance or the like, the virtual NIC 200a determines that division of the network is resolved.

Here, the method of determining presence or absence of division of the network to which the NICs 201, 202, and 203 are connected is summarized as below.

As the physical state of a physical NIC, “UP” and “DOWN” are defined. “UP” is a link-up state of a physical NIC, and is a state where communication is enabled. “DOWN” is a link-down state where a physical NIC is broken down, for example, and is a state where communication is disabled.

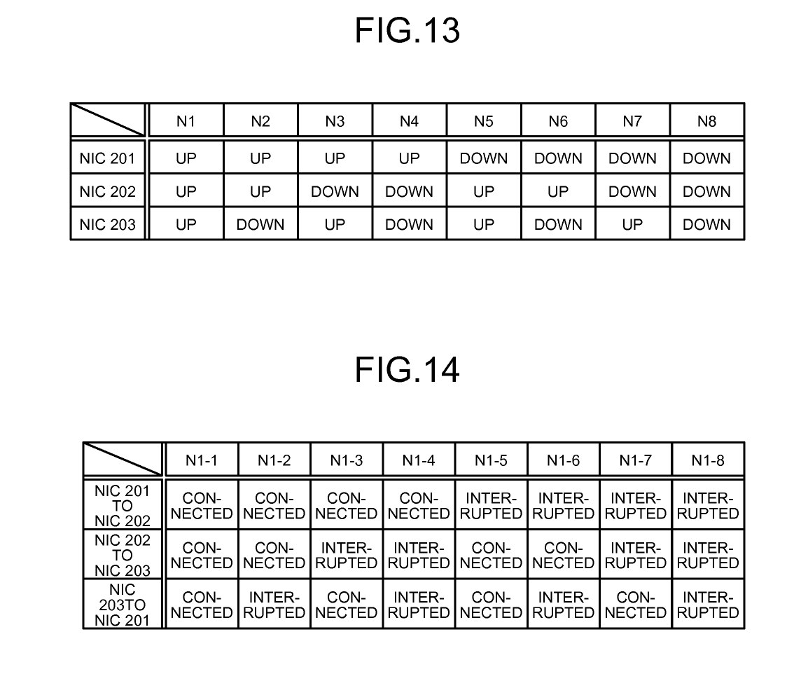

When the state of a physical NIC is defined as above, there will be eight combinations of states of the NICs 201 to 203, namely, states N1 to N8, as illustrated in FIG. 13. FIG. 13 is a diagram illustrating combinations of the states of physical NICs. The state N1 is a state where all the NICs 201 to 203 are usable. The states N2, N3, and N5 are states where two out of three NICs are usable. The states N4, N6, and N7 are states where one out of three NICs is usable. The state N8 is a state where all the NICs 201 to 203 are unusable.

Among the states N1 to N8 illustrated in FIG. 13, monitoring of the state of the network topology is possible in four states where two or more physical NICs are usable, namely, the states N1, N2, N3, and N5. The virtual NIC 200a performs monitoring of the network topology by the following path in each state.

In the case of the state N1, the virtual NIC 200a performs monitoring between the NIC 201 and the NIC 202, between the NIC 202 and the NIC 203, and between the NIC 203 and the NIC 201. In the case of the state N2, the virtual NIC 200a performs monitoring between the NIC 201 and the NIC 202. In the case of the state N3, the virtual NIC 200a performs monitoring between the NIC 203 and the NIC 201. In the case of the state N5, the virtual NIC 200a performs monitoring between the NIC 202 and the NIC 203.

Evaluation of the network topology in the case where the state of physical NICs is “state N1” will be described. In the case where all the physical NICs are in the link-up state, there will be eight types of states of network topology monitoring, namely, N1-1 to N1-8, as illustrated in FIG. 14. FIG. 14 is a diagram (1) illustrating the states of network topology monitoring. In FIG. 14, “NIC 201-NIC 202” indicates the path between the NIC 201 and the NIC 202. “NIC 202-NIC 203” indicates the path between the NIC 202 and the NIC 203. “NIC 203-NIC 201” indicates the path between the NIC 203 and the NIC 201.

For example, in the case the state of the network topology monitoring is “N1-1” in FIG. 14, all the paths are normal. In the case the state of the network topology monitoring is “N1-1”, the virtual NIC 200a determines that the network is not divided.

In the case the state of the network topology monitoring is “N1-2”, the path between the NIC 201 and the NIC 203 is interrupted. However, both the path from the NIC 202 to the NIC 201 and the path from the NIC 202 to the NIC 203 are connected. In the case the state of the network topology monitoring is “N1-2”, the NIC 202 is connected to all the other physical NICs, and thus, the virtual NIC 200a determines that the network is not divided.

In the case the state of the network topology monitoring is “N1-3”, the path between the NIC 202 and the NIC 203 is interrupted. However, the path from the NIC 201 to the NIC 202 and the path from the NIC 201 to the NIC 203 are connected. In the case the state of the network topology monitoring is “N1-3”, the NIC 201 is connected to all the other physical NICs, and thus, the virtual NIC 200a determines that the network is not divided.

In the case the state of the network topology monitoring is “N1-4”, the path between the NIC 202 and the NIC 203 is interrupted, and the path between the NIC 203 and the NIC 201 is interrupted. In the case the state of the network topology monitoring is “N1-4”, the virtual NIC 200a determines that the network is divided into two, between the NIC 203 and other physical NICs.

In the case the state of the network topology monitoring is “N1-5”, the path between the NIC 201 and the NIC 202 is interrupted. However, both the path from the NIC 203 to the NIC 201 and the path from the NIC 202 to the NIC 203 are connected. In the case the state of the network topology monitoring is “N1-5”, the NIC 203 is connected to all the other physical NICs, and thus, the virtual NIC 200a determines that the network is not divided.

In the case the state of the network topology monitoring is “N1-6”, the path between the NIC 201 and the NIC 202 is interrupted, and the path between the NIC 203 and the NIC 201 is interrupted. In the case the state of the network topology monitoring is “N1-6”, the virtual NIC 200a determines that the network is divided into two, between the NIC 201 and other physical NICs.

In the case the state of the network topology monitoring is “N1-7”, the path between the NIC 201 and the NIC 202 is interrupted, and the path between the NIC 202 and the NIC 203 is interrupted. In the case the state of the network topology monitoring is “N1-7”, the virtual NIC 200a determines that the network is divided into two, between the NIC 202 and other physical NICs.

In the case the state of the network topology monitoring is “N1-8”, all the paths are interrupted. In the case the state of the network topology monitoring is “N1-8”, the virtual NIC 200a determines that the network is divided into three, among all the physical NICs.

According to the above, if heartbeat messages are interrupted between a certain physical NIC and all the other physical NICs, the virtual NIC 200a determines that the network to which the certain physical NIC is connected is separated from the network topology to which other physical NICs are connected. In the case an abnormality or recovery of heartbeat messages is detected, the virtual NIC 200a checks the state of the network topology, and follows the change in the network topology, and load balancing by the MAC address is thereby enabled.

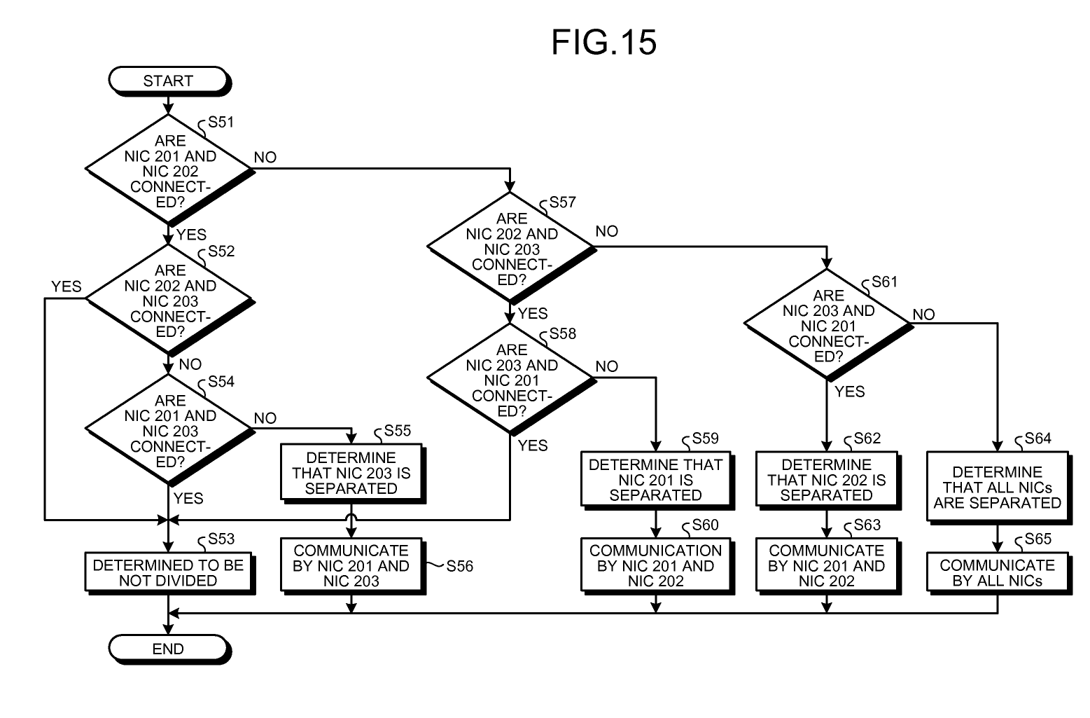

Here, a processing procedure of the virtual NIC 200a for determining a topology state of the network in the state N1 will be described. FIG. 15 is a flow chart illustrating a processing procedure of the virtual NIC according to the third embodiment for determining a topology state of the network. The process illustrated in FIG. 15 is regularly performed. As illustrated in FIG. 15, the virtual NIC 200a determines whether the NIC 201 and the NIC 202 are connected (step S51).

In the case the NIC 201 and the NIC 202 are connected (step S51: Yes), the virtual NIC 200a determines whether the NIC 202 and the NIC 203 are connected (step S52). In the case the NIC 202 and the NIC 203 are connected (step S52: Yes), the virtual NIC 200a determines that the network is not divided (step S53).

Step S52 will be described again. In the case the NIC 202 and the NIC 203 are not connected (step S52: No), the virtual NIC 200a determines whether the NIC 201 and the NIC 203 are connected (step S54). In the case the NIC 201 and the NIC 203 are connected (step S54: Yes), the virtual NIC 200a proceeds to step S53.

On the other hand, in the case the NIC 201 and the NIC 203 are not connected (step S54: No), the virtual NIC 200a determines that the NIC 203 is separated (step S55). The virtual NIC 200a performs communication by the NIC 201 and the NIC 203 (step S56).

Step S51 will be described again. In the case the NIC 201 and the NIC 202 are not connected (step S51: No), the virtual NIC 200a determines whether the NIC 202 and the NIC 203 are connected (step S57).

In the case the NIC 202 and the NIC 203 are connected (step S57: Yes), the virtual NIC 200a determines whether the NIC 203 and the NIC 201 are connected (step S58). In the case the NIC 203 and the NIC 201 are connected (step S58: Yes), the virtual NIC 200a proceeds to step S53.

On the other hand, in the case the NIC 203 and the NIC 201 are not connected (step S58: No), the virtual NIC 200a determines that the NIC 201 is separated (step S59). The virtual NIC 200a performs communication by the NIC 201 and the NIC 202 (step S60).

Step S57 will be described again. In the case the NIC 202 and the NIC 203 are not connected (step S57: No), the virtual NIC 200a determines whether the NIC 203 and the NIC 201 are connected (step S61).

In the case the NIC 203 and the NIC 201 are connected (step S61: Yes), the virtual NIC 200a determines that the NIC 202 is separated (step S62). The virtual NIC 200a performs communication by the NIC 201 and the NIC 202 (step S63).

On the other hand, in the case the NIC 203 and the NIC 201 are not connected (step S61: No), the virtual NIC 200a determines that the NICs 201, 202, and 203 are all separated (step S64). The virtual NIC 200a performs communication by all of the NICs 201, 202, and 203 (step S65).

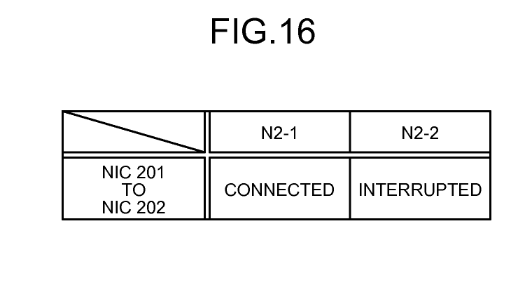

Evaluation of the network topology in a case where the state of physical NICs is “state N2” will be described. In the case the NIC 203, among three physical NICs, is broken down, network topology monitoring is performed only between the NIC 201 and the NIC 202. In the case the state is “state N2”, there will be two types of states of network topology monitoring, namely, N2-1 and N2-2, as illustrated in FIG. 16. FIG. 16 is a diagram (2) illustrating states of network topology monitoring.

In FIG. 16, in the case the state of network topology monitoring is “N2-1”, all the paths are normal. In the case the state of network topology monitoring is “N2-1”, the virtual NIC 200a determines that the network is not divided.

In the case the state of network topology monitoring is “N2-2”, the path between the NIC 201 and the NIC 202 is interrupted. In the case the state of network topology monitoring is “N2-2”, the virtual NIC 200a determines that the network is divided into two between the NIC 201 and the NIC 202.

Incidentally, with respect to the evaluation of the network topology in the case where the state of the physical NICs is “state N3 or N5”, the only difference to the case where the state of the physical NICs is “state N2” is the physical NIC that is broken down, and division of the network is determined in the same manner.

Next, an effect of the system depicted in the third embodiment will be described. The virtual NIC 200a detects division of the network by transmitting/receiving heartbeat messages between the physical NICs. In the case division of the network is detected, the virtual NIC 200a registers the relationship between each physical NIC and the client in a reachable network in the virtual MAC address table 215. The virtual NIC 200a associates a physical NIC capable of reaching the connection destination and a virtual machine, based on the virtual MAC address table 215, and performs communication between the physical NIC and the client. Accordingly, even if a single network segment is divided into a plurality of segments due to breakdown of a switch or interruption of a link between switches, communication between each virtual machine and each client may be maintained.

### [d] Fourth Embodiment

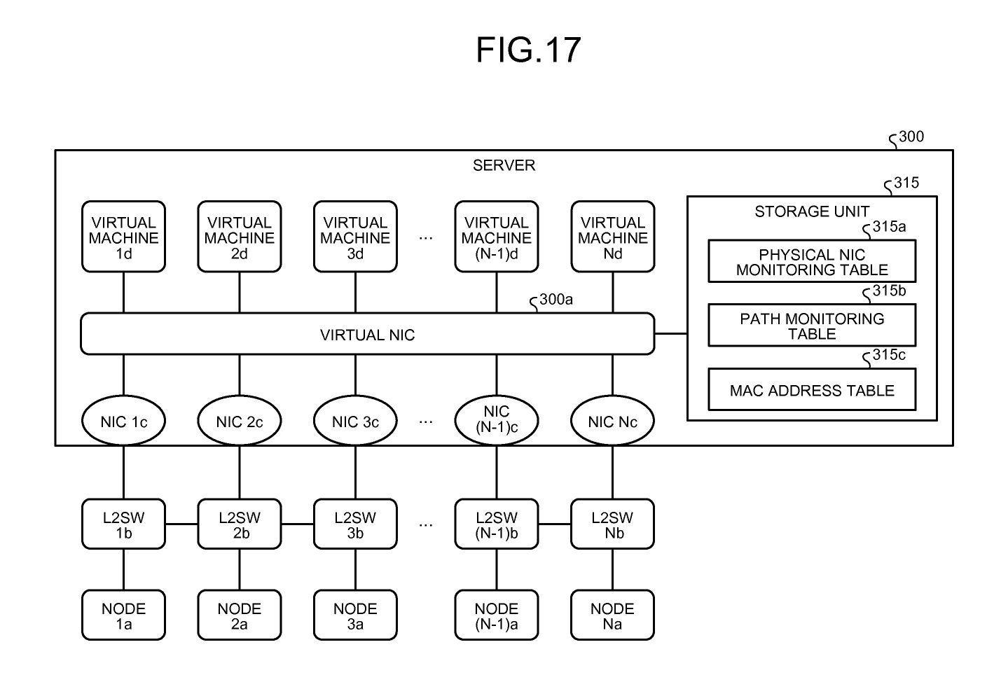

Now, a configuration of a system according to a fourth embodiment will be described. FIG. 17 is a diagram for describing a configuration of the system according to the fourth embodiment. As illustrated in FIG. 17, this system includes nodes 1a to Na, L2SWs 1b to Nb, and a server 300. The server 300 includes NICs 1c to Nc, a virtual NIC 300a, and virtual machines 1d to Nd.

The nodes 1a to Na are nodes to be the communication counterparts of the virtual machines 1d to Nd.

The L2SW 1b to Nb are layer 2 switches to which physical NICs are to be connected. The L2SWs 1b to Nb configure a single network segment. The NICs 1c to Nc are connected to the L2SWs 1b to Nb, respectively.

The NICs 1c to Nc are NICs to be teamed by the virtual NIC 300a. The NICs 1c to Nc are collectively referred to as physical NIC(s) as appropriate.

The virtual NIC 300a is a virtual NIC that teams the NICs 1c to Nc. The virtual NIC 300a performs communication using Layer 2 protocol such as the Ethernet by using the NICs 1c to Nc.

The virtual machines 1d to Nd are virtual machines that perform communication by using a virtual NIC. The virtual machines 1d to Nd, in the case all the appliances are normally operating, performs communication by using a corresponding NIC Xc. Here, “all the appliances” include the L2SWs 1b to Nb and the NICs 1c to Nc, for example. The virtual machine Xd indicates one virtual machine among the virtual machines 1d to Nd. The NIC Xc indicates one NIC among the NICs 1c to Nc.

Furthermore, in the case the NIC Xc breaks down, the virtual machine Xd performs communication by using a NIC (X+1)c. Also, in the case the NIC (X+1)c breaks down, the virtual machine Xd performs communication by using a NIC (X+2)c.

In the case an abnormality occurs in the connection between the L2SWs, and the network is divided, the virtual machines 1d to Nd perform communication by using one physical NIC for each separated network. Additionally, the physical NIC to be used by the virtual machine is controlled by the virtual NIC 300a.

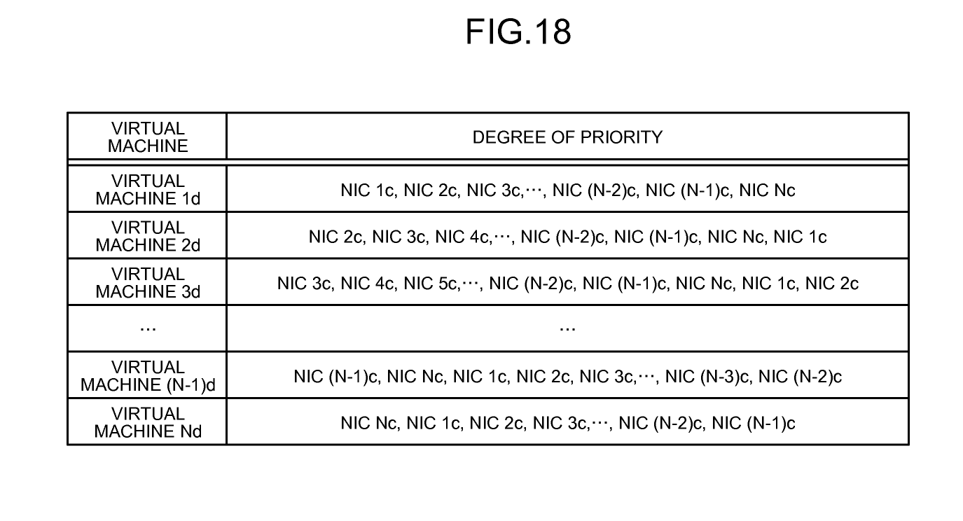

The virtual NIC 300a selects the NICs to be used by the virtual machines 1d to Nd according to the degree of priority illustrated in FIG. 18. FIG. 18 is a diagram illustrating an example of the degree of priority of each NIC for each virtual machine. In FIG. 18, a virtual machine and the degree of priority are associated. With respect to the physical NICs included in the degree of priority, one on the left side is with a high degree of priority, and one on the right side is with a low degree of priority. For example, the physical NIC with the highest degree of priority for the virtual machine 1d is the NIC 1c. On the other hand, the physical NIC with the lowest degree of priority for the virtual machine 1d is the NIC Nc. In the case the physical NIC that is being used by a virtual machine breaks down, the virtual NIC 300a selects the physical NIC with the highest degree of priority, among the physical NICs that are not broken down, as the physical NIC for the virtual machine.

The virtual NIC 300a exchanges heartbeat messages between the teamed NICs, and detects division or recovery of the network, in the same manner as the virtual NICs 100a and 200a of the second and third Embodiments. For example, in the case the number of physical NICs is N, the number of paths to be monitored is as expressed by Equation (1).

The number of paths to be monitored=N×(N−1)÷2 (1)

It can be seen from Equation (1) that, in the case the number of physical NICs to be teamed is increased, the paths to be monitored are exponentially increased in accordance. If the number of physical NICs to be teamed is two to three, there are one to three paths to be monitored, and all the paths may be easily monitored. However, in the case a larger number of physical NICs are teamed, it is inefficient to monitor all the paths at all times. For example, in the case the virtual NIC 300a teams ten physical NICs, there are 45 paths to be monitored according to Equation (1), but it is unrealistic to individually monitor all these paths at all times.

The aim of network topology monitoring is to determine whether the network topology is divided, and where it is divided. Accordingly, the virtual NIC 300a does not have to monitor all the paths. In the following, the process of the virtual NIC 300a for efficiently determining presence or absence of division of a network and determining where it is divided will be described.

The virtual NIC 300a defines condition A for determining physical separation of a network to which an NIC Xc to be used for communication of a virtual machine Xd is connected from other physical NICs. Additionally, the NIC Yc included in condition A below is assumed to be the physical NIC with the highest degree of priority among the physical NICs to be used by the virtual machine Xd.

“All the heartbeats to NICs Yc to (X−1)c with higher degrees of priority than the NIC Xc are interrupted” . . . Condition A

In the case condition A above is satisfied, the virtual NIC 300a performs communication of the virtual machine Xd by using the NIC Xc. Then, if the heartbeat message is conveyed in any of the paths, the virtual NIC 300a stops using the NIC Xc. However, if the NIC Xc is the physical NIC with the highest degree of priority among all the physical NICs, the virtual NIC 300a continues using the NIC Xc.

For example, in the case of communication of the virtual machine 1d, the virtual NIC 300a determines whether each physical NIC is to be used for the communication in the following manner. Additionally, it is assumed here that none of the physical NICs is broken down.

The virtual NIC 300a uses “NIC 1c” for the communication of the virtual machine 1d at all times regardless of the result of monitoring. The NIC 1c will not be suspended.

In the case the heartbeat messages between the NIC 2c and the NIC 1c are interrupted, the virtual NIC 300a uses “NIC 2c” for the communication of the virtual machine 1d.

In the case all the heartbeat messages between the NIC 3c and the NIC 2c, and between the NIC 3c and the NIC 1c are interrupted, the virtual NIC 300a uses “NIC 3c” for the communication of the virtual machine 1d. In the case the heartbeat messages are conveyed in at least one path, the virtual NIC 300a suspends the use of the NIC 3c.

The virtual NIC 300a assumes that the heartbeat messages are interrupted between the NIC (N−1)c and the NIC (N−2)c, between the NIC (N−1)c and the NIC (N−3)c, . . . , between the NIC (N−1)c and the NIC 2c, and between the NIC (N−1)c and the NIC 1c. In this case, the virtual NIC 300a uses “NIC (N−1)c” for the communication of the virtual machine 1d.

The virtual NIC 300a assumes that the heartbeat messages are interrupted between the NIC Nc and the NIC (N−1)c, between the NIC Nc and the NIC (N−2)c, . . . , between the NIC Nc and the NIC 2c, and between the NIC Nc and the NIC 1c. In this case, the virtual NIC 300a uses “NIC Nc” for the communication of the virtual machine 1d

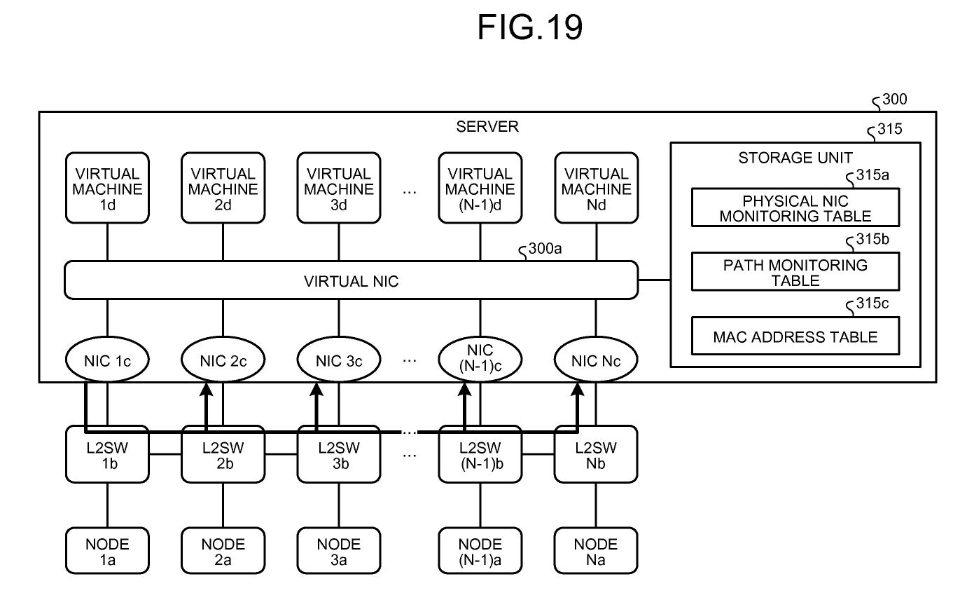

Next, the process of the virtual NIC 300a for checking that the network is not divided will be described. FIG. 19 is a diagram for describing a process of a virtual NIC of the fourth embodiment for checking that the network is not divided. The virtual NIC 300a multicasts or broadcasts a heartbeat message from one of teamed physical NICs. If the heartbeat message is received by all the other physical NICs, the virtual NIC 300a determines that the network is not divided.

For example, in the example illustrated in FIG. 19, the virtual NIC 300a broadcasts a heartbeat message from the NIC 1c to other NICs 2c to Nc. In the case the heartbeat message broadcasted by the NIC 1c reached the NICs 2c to Nc, the virtual NIC 300a determines that the network is not divided.

On the other hand, if there is even one physical NIC that did not receive the heartbeat message after the broadcasting of the heartbeat message, the virtual NIC 300a performs identification of the divided part.

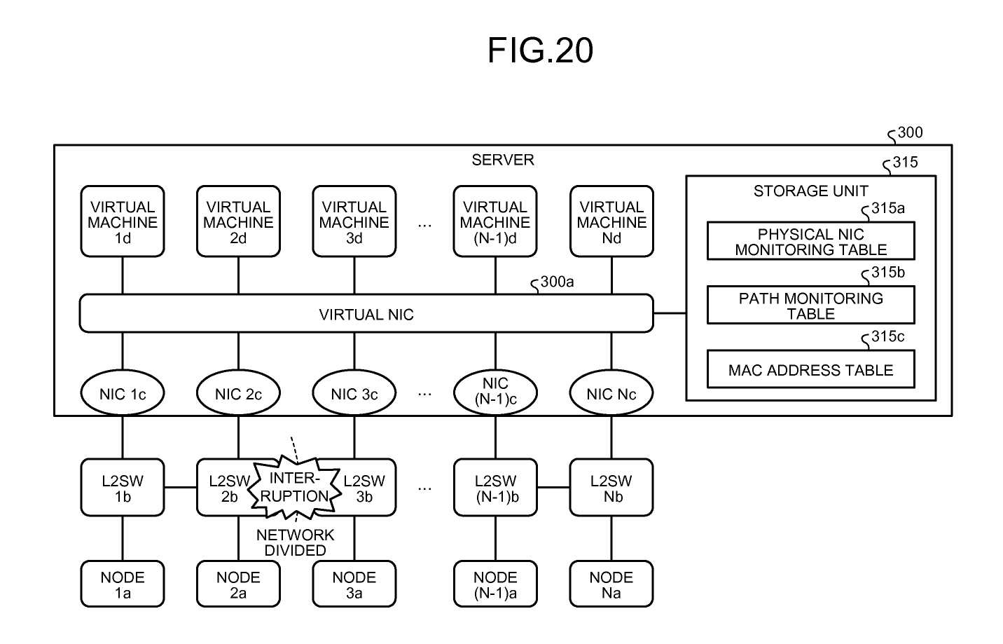

Next, the process of the virtual NIC 300a for performing identification of a divided part will be described. FIG. 20 is a diagram (1) for describing the process of the virtual NIC of the fourth embodiment for identifying a divided part. In the case of performing identification of a divided part, the virtual NIC 300a broadcasts or multicasts a heartbeat message from each physical NIC. The virtual NIC 300a determines the divided part of the network based on which physical NIC(s) has (have) received the heartbeat message transmitted.

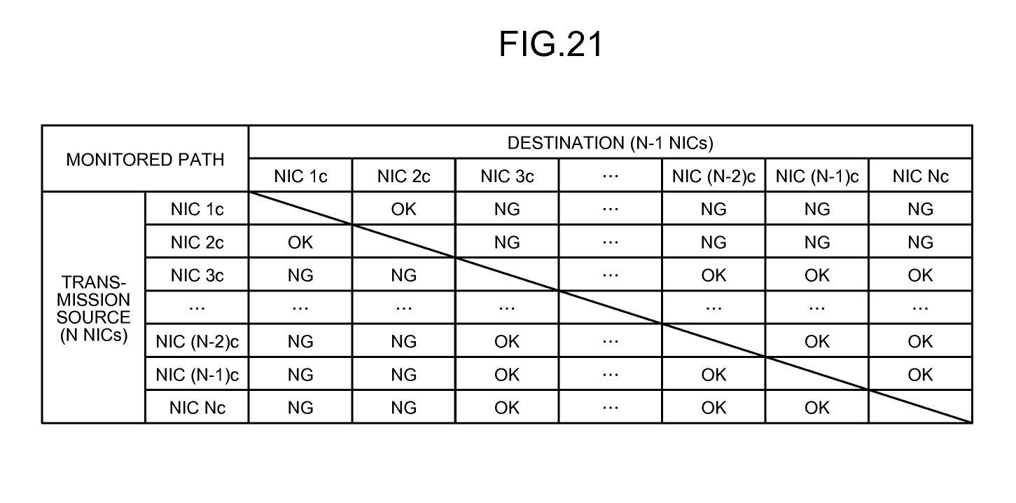

For example, a case where the connection between the L2SW 2b and the L2SW 3b is cut off, and the network topology is divided into two, as illustrated in FIG. 20, will be described. In the case the network is divided into two as illustrated in FIG. 20, the reaching state of the heartbeat message transmitted from each physical NIC will be as illustrated in FIG. 21.

FIG. 21 is a diagram illustrating a reaching state of a heartbeat message where the network is divided into two as illustrated in FIG. 20. In FIG. 21, the transmission source indicates the physical NIC which has broadcasted the heartbeat message. The destination is the physical NIC which is the destination of the heartbeat message. In FIG. 21, “OK” indicates that the heartbeat message is received. “NG” indicates that the heartbeat message is not received.

For example, at the top in FIG. 21, the heartbeat message broadcasted by the NIC 1c is received by the NIC 2c. On the other hand, the heartbeat message broadcasted by the NIC 1c is not received by the NICs 3c to Nc.

In the case the reaching state of the heartbeat message is as illustrated in FIG. 21, the virtual NIC 300a determines that the network to which the NICs 1c and 2c are connected and the network to which the NICs 3c to Nc are connected are separated.

In the case the reaching state of the heartbeat message is as illustrated in FIG. 21, the virtual NIC 300a selects the physical NIC to be used by each virtual machine in the following manner. For example, the virtual NIC 300a selects, for each network, a physical NIC with a higher degree of priority among the physical NICs connected to the separated network. The degrees of priority of physical NICs for each virtual machine are illustrated in FIG. 18. The physical NICs to be used by the virtual machines 1d, 2d, 3d, (N−1)d, and Nd will be described as an example.

The physical NIC to be used by the virtual machine 1d will be described. The virtual NIC 300a selects “NIC 1c” as the physical NIC to be used by the virtual machine 1d regardless of the reaching state of the heartbeat message. Also, in the case of a situation as illustrated in FIG. 21, the virtual NIC 300a further selects “NIC 3c” as the physical NIC to be used by the virtual machine 1d.

The physical NIC to be used by the virtual machine 2d will be described. The virtual NIC 300a selects “NIC 2c” as the physical NIC to be used by the virtual machine 2d regardless of the reaching state of the heartbeat message. Also, in the case of a situation as illustrated in FIG. 21, the virtual NIC 300a further selects “NIC 3c” as the physical NIC to be used by the virtual machine 2d.

The physical NIC to be used by the virtual machine 3d will be described. The virtual NIC 300a selects “NIC 3c” as the physical NIC to be used by the virtual machine 3d regardless of the reaching state of the heartbeat message. Also, in the case of a situation as illustrated in FIG. 21, the virtual NIC 300a further selects “NIC 1c” as the physical NIC to be used by the virtual machine 3d.

The physical NIC to be used by the virtual machine (N−1)d will be described. The virtual NIC 300a selects “NIC (N−1)c” as the physical NIC to be used by the virtual machine (N−1)d regardless of the reaching state of the heartbeat message. Also, in the case of a situation as illustrated in FIG. 21, the virtual NIC 300a further selects “NIC 1c” as the physical NIC to be used by the virtual machine (N−1)d.

The physical NIC to be used by the virtual machine Nd will be described. The virtual NIC 300a selects “NIC Nc” as the physical NIC to be used by the virtual machine Nd regardless of the reaching state of the heartbeat message. Also, in the case of a situation as illustrated in FIG. 21, the virtual NIC 300a further selects “NIC 1c” as the physical NIC to be used by the virtual machine Nd.

As described above, the virtual NIC 300a selects, for each virtual machine, physical NICs one each connected to the networks divided into two, from N NICs that are teamed, and thus, each virtual machine may maintain communication with each node.

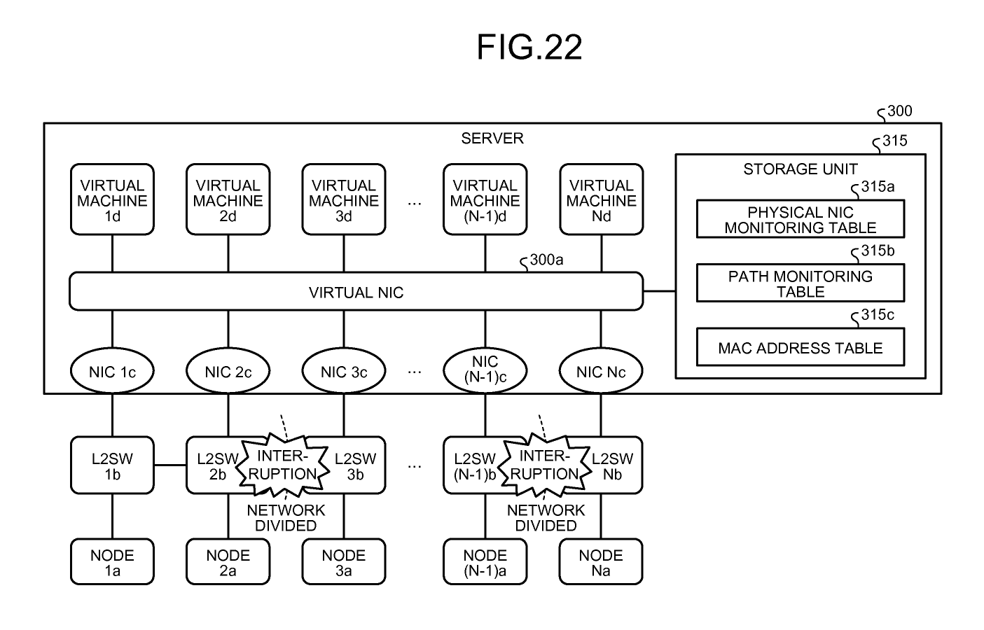

A case where the network is divided into two is described with reference to FIG. 20. Next, a process of identifying a point where the network is divided into three will be described. FIG. 22 is a diagram (2) for describing the process of the virtual NIC of the fourth embodiment for identifying a divided part.

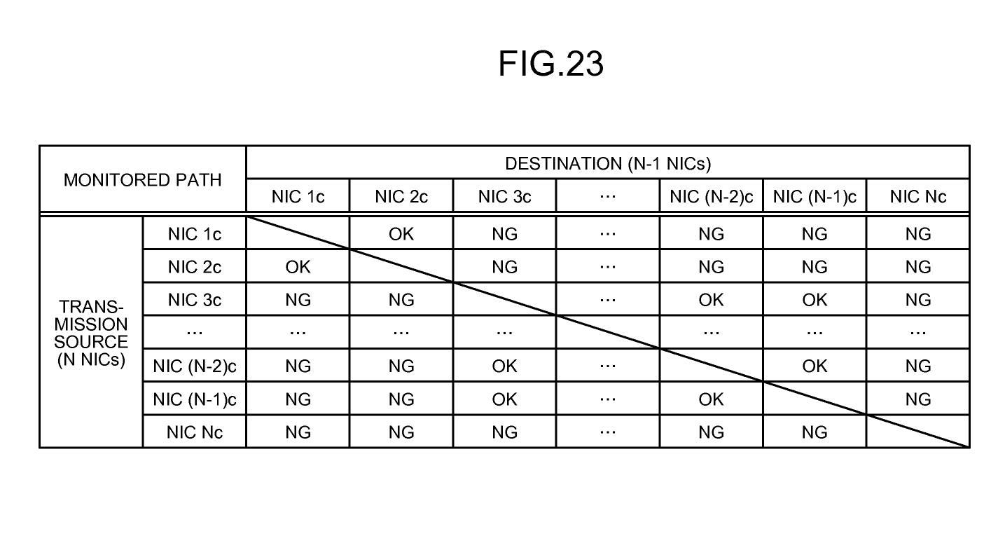

For example, in the case where the connection between the L2SW 2b and the L2SW 3b is cut off, and the connection between the L2SW (N−1)b and the L2SW Nb is cut off, as illustrated in FIG. 22, the reaching state of the heartbeat message will be as illustrated in FIG. 23.

FIG. 23 is a diagram illustrating the reaching state of a heartbeat message where the network is divided into three as illustrated in FIG. 22. In FIG. 23, the transmission source indicates the physical NIC which has broadcasted the heartbeat message. The destination is the physical NIC which is the destination of the heartbeat message. In FIG. 23, “OK” indicates that the heartbeat message is received. “NG” indicates that the heartbeat message is not received.

For example, at the top in FIG. 23, the heartbeat message broadcasted by the NIC 1c is received by the NIC 2c. On the other hand, the heartbeat message broadcasted by the NIC 1c is not received by the NICs 3c to Nc.

In the case the reaching state is as illustrated in FIG. 23, the virtual NIC 300a determines that the network to which the NICs 1c and 2c are connected, the network to which the NICs 3c to (N−1)c, and the network to which the NIC Nc is connected are separated.

In the case the reaching state of the heartbeat message is as illustrated in FIG. 23, the virtual NIC 300a selects the physical NIC to be used by each virtual machine in the following manner. For example, the virtual NIC 300a selects, for each network, a physical NIC with a higher degree of priority among the physical NICs connected to each separate network. The degrees of priority of physical NICs for each virtual machine are illustrated in FIG. 18. The physical NICs to be used by the virtual machines 1d, 2d, 3d, (N−1)d, and Nd will be described as an example.

The physical NIC to be used by the virtual machine 1d will be described. The virtual NIC 300a selects “NIC 1c” as the physical NIC to be used by the virtual machine 1d regardless of the reaching state of the heartbeat message. Also, in the case of a situation as illustrated in FIG. 23, the virtual NIC 300a further selects “NIC 3c” and “NIC Nc” as the physical NICs to be used by the virtual machine 1d.

The physical NIC to be used by the virtual machine 2d will be described. The virtual NIC 300a selects “NIC 2c” as the physical NIC to be used by the virtual machine 2d regardless of the reaching state of the heartbeat message. Also, in the case of a situation as illustrated in FIG. 23, the virtual NIC 300a further selects “NIC 3c” and “NIC Nc” as the physical NICs to be used by the virtual machine 2d.

The physical NIC to be used by the virtual machine 3d will be described. The virtual NIC 300a selects “NIC 3c” as the physical NIC to be used by the virtual machine 3d regardless of the reaching state of the heartbeat message. Also, in the case of a situation as illustrated in FIG. 23, the virtual NIC 300a further selects “NIC 1c” and “NIC Nc” as the physical NICs to be used by the virtual machine 3d.

The physical NIC to be used by the virtual machine (N−1)d will be described. The virtual NIC 300a selects “NIC (N−1)c” as the physical NIC to be used by the virtual machine (N−1)d regardless of the reaching state of the heartbeat message. Also, in the case of a situation as illustrated in FIG. 23, the virtual NIC 300a further selects “NIC 1c” and “NIC Nc” as the physical NICs to be used by the virtual machine (N−1)d.

The physical NIC to be used by the virtual machine Nd will be described. The virtual NIC 300a selects “NIC Nc” as the physical NIC to be used by the virtual machine Nd regardless of the reaching state of the heartbeat message. Also, in the case of a situation as illustrated in FIG. 23, the virtual NIC 300a further selects “NIC 1c” and “NIC 3c” as the physical NICs to be used by the virtual machine Nd.

As described above, the virtual NIC 300a selects, for each virtual machine, physical NICs one each connected to the networks divided into three, from N NICs that are teamed, and thus, each virtual machine may maintain communication with each node.

Next, an algorithm for the virtual NIC 300a to determine the path state will be described. The virtual NIC 300a uses a physical NIC monitoring table 315a and a path monitoring table 315b. The physical NIC monitoring table 315a and the path monitoring table 315b are stored in a storage unit 315.

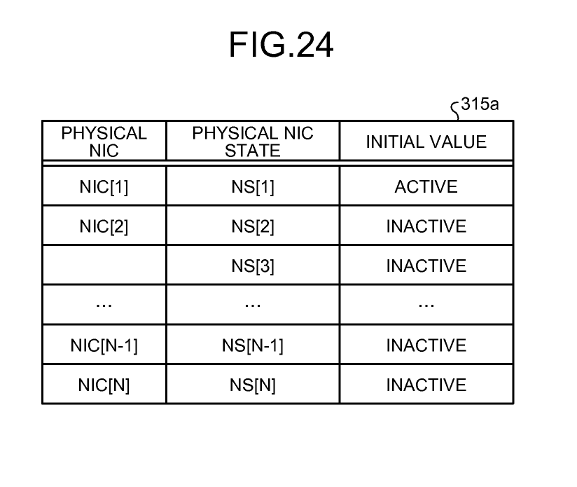

FIG. 24 is a diagram illustrating an example of a data structure of the physical NIC monitoring table. As illustrated in FIG. 24, the physical NIC monitoring table 315a stores a physical NIC, a physical NIC state, and an initial value in association with one another.

Regarding the physical NICs in FIG. 24, NIC[1] to NIC[N] are defined in the descending order of priority with respect to the NICs which are the targets of teaming. Also, regarding the physical NIC state, variables NS[1] to NS[N] are defined to store whether each NIC is to be used for communication. The NS[1] to NS[N] are in the descending order of priority. The initial value of the NS[1] is always ACTIVE. The initial value is INACTIVE for the NS[2] and after. ACTIVE indicates use in the communication of a virtual machine. INACTIVE indicates non-use in the communication of a virtual machine. The NS[2] and after will be ACTIVE in the case they are determined to be used in the communication as a result of checking the state of the network topology.

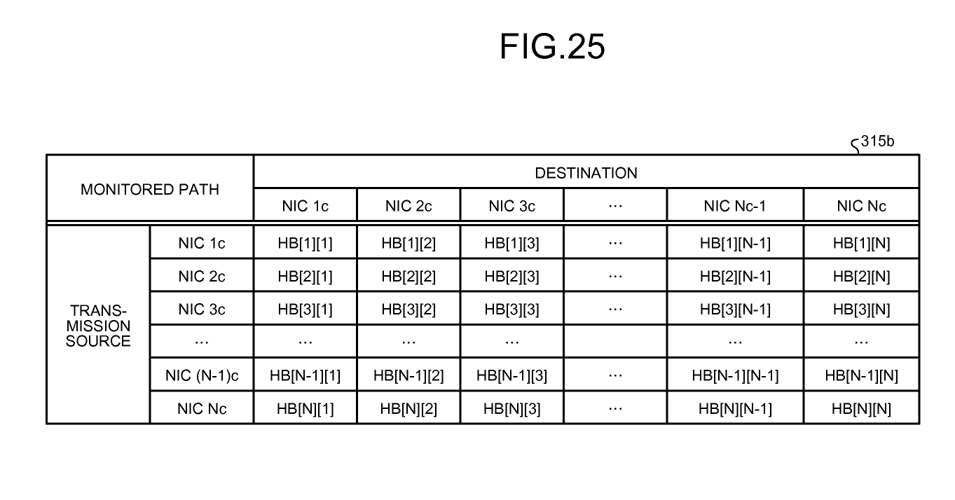

FIG. 25 is a diagram illustrating an example of a data structure of the path monitoring table. As illustrated in FIG. 25, an N×N array HB[X][Y] is defined as the variable for storing the result of transmission of the heartbeat messages. The initial value of each array HB is NG, and OK is set when the heartbeat message is conveyed. Additionally, in FIG. 25, a transmission source is the transmission source of the heartbeat message. A destination is the destination of the heartbeat message.

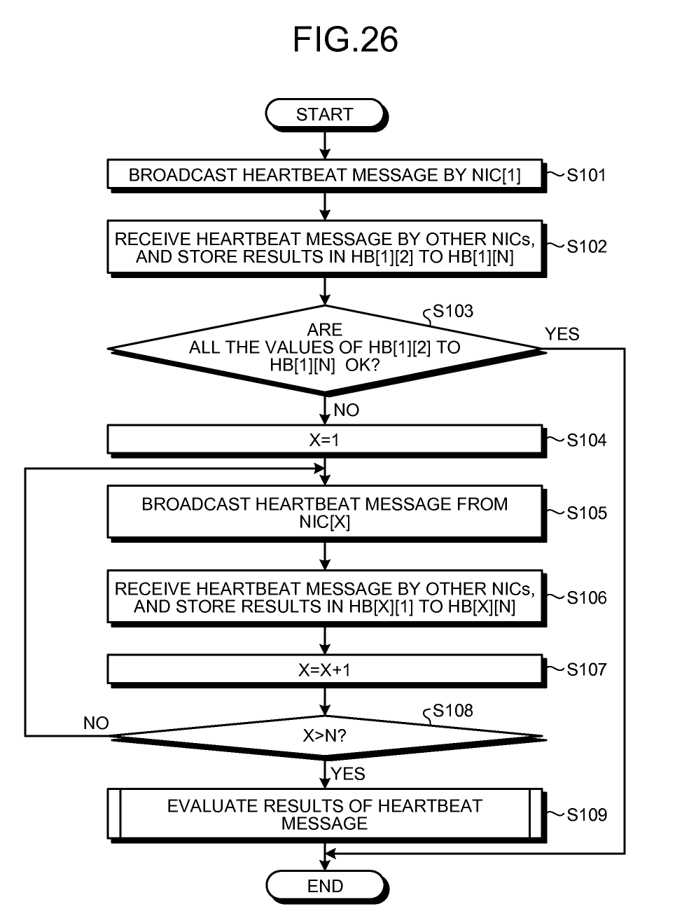

A processing procedure of the virtual NIC 300a that uses the physical NIC monitoring table 315a illustrated in FIG. 24 and the path monitoring table 315b illustrated in FIG. 25 will be described with reference to the flow chart in FIG. 26. FIG. 26 is a flow chart illustrating a processing procedure of the virtual NIC according to the fourth embodiment for determining a path state. For example, the process illustrated in FIG. 26 is regularly performed by the virtual NIC 300a.

As illustrated in FIG. 26, the virtual NIC 300a broadcasts a heartbeat message by the NIC[1] (step S101). The virtual NIC 300a receives the heartbeat message by other NICs, and stores the results in HB[1][2] to HB[1][N] of the path monitoring table 315b (step S102). In the case the heartbeat message is received in step S102, the virtual NIC 300a sets “OK”, and in the case the heartbeat message is not received, the virtual NIC 300a sets “NG”.

The virtual NIC 300a determines whether all the values of HB[1][2] to HB[1][N] are OK (step S103). In the case all the values of HB[1][2] to HB[1][N] are OK (step S103: Yes), the virtual NIC 300a ends the process.

On the other hand, in the case not all the values of HB[1][2] to HB[1][N] are OK (step S103: No), the virtual NIC 300a sets 1 to a variable X (step S104).

The virtual NIC 300a broadcasts a heartbeat message by the NIC[X] (step S105). The virtual NIC 300a receives the heartbeat message by other NICs, and stores the results in HB[X][1] to HB[X][N] of the path monitoring table 315b (step S106).

The virtual NIC 300a sets a value obtained by adding 1 to the value of the variable X to the variable X (step S107). The virtual NIC 300a determines whether the value of the variable X is greater than the value of N (step S108). In the case the value of the variable X is equal to or smaller than the value of N (step S108: No), the virtual NIC 300a proceeds to step S105.

On the other hand, in the case the value of the variable X is greater than the value of N (step S108: Yes), the virtual NIC 300a evaluates the results of the heartbeat message (step S109).

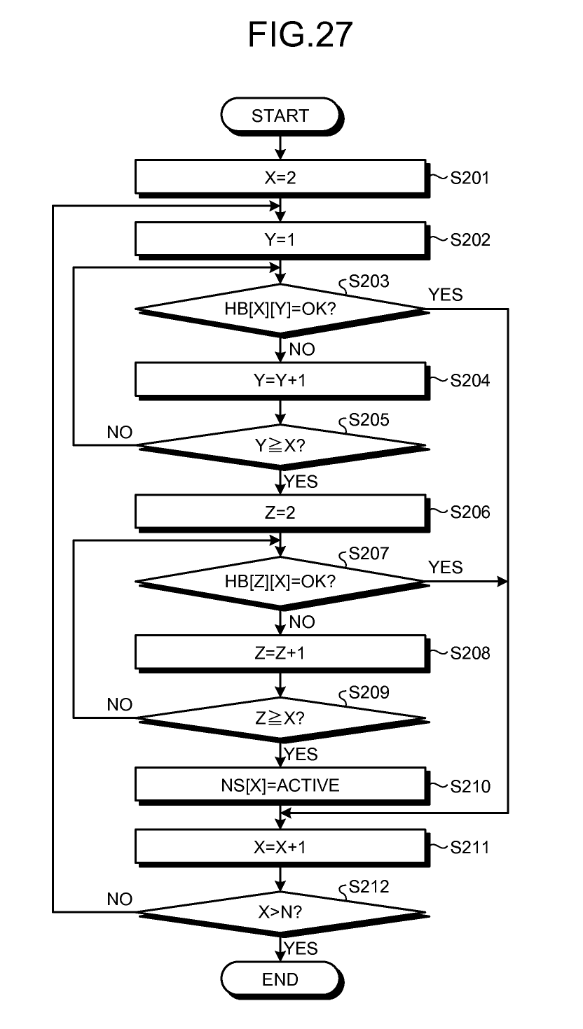

Here, the processing procedure of evaluating the results of the heartbeat message indicated by step S109 in FIG. 26 will be concretely described. FIG. 27 is a flow chart illustrating a processing procedure for evaluating the results of the heartbeat message.

As illustrated in FIG. 27, the virtual NIC 300a sets 2 to the value of the variable X (step S201), and sets 1 to the value of the variable Y (step S202). The virtual NIC 300a determines whether the information set in HB[X][Y] of the path monitoring table 315b is OK (step S203). In the case the information set in HB[X][Y] of the path monitoring table 315b is OK (step S203: Yes), the virtual NIC 300a proceeds to step S211.

On the other hand, in the case the information set in HB[X][Y] of the path monitoring table 315b is not OK (step S203: No), the virtual NIC 300a sets a value obtained by adding 1 to the value of the variable Y to the variable Y (step S204). The virtual NIC 300a determines whether the value of the variable Y is equal to or greater than the variable X (step S205).

In the case the value of the variable Y is not equal to or greater than the variable X (step S205: No), the virtual NIC 300a proceeds to step S203. On the other hand, in the case the value of the variable Y is equal to or greater than the value of the variable X (step S205: Yes), the virtual NIC 300a sets 2 to the value of the variable Z (step S206).

The virtual NIC 300a determines whether the information set in HB[Z][X] of the path monitoring table 315b is OK (step S207). In the case the information set in HB[Z][X] of the path monitoring table 315b is OK (step S207: Yes), the virtual NIC 300a proceeds to step S211. On the other hand, in the case the information set in HB[Z][X] of the path monitoring table 315b is not OK (step S207: No), the virtual NIC 300a sets a value obtained by adding 1 to the value of the variable Z to the variable Z (step S208).

The virtual NIC 300a determines whether the value of the variable Z is equal to or greater than the variable X (step S209). In the case the value of the variable Z is not equal to or greater than the variable X (step S209: No), the virtual NIC 300a proceeds to step S207.

On the other hand, in the case the value of the variable Z is equal to or greater than the variable X (step S209: Yes), the virtual NIC 300a sets the information of NS[X] in the physical NIC monitoring table 315a to ACTIVE (step S210). The virtual NIC 300a sets a value obtained by adding 1 to the value of the variable X to the variable X (step S211).

The virtual NIC 300a determines whether the value of X is greater than the value of N (step S212). In the case the value of X is not greater than the value of N (step S212: No), the virtual NIC 300a proceeds to step S202. On the other hand, in the case the value of X is greater than the value of N (step S212: Yes), the virtual NIC 300a ends the process.

Next, a packet transmission procedure for a case where the network is divided will be described. In the case the network is divided, the virtual NIC 300a uses any of physical NICs in the ACTIVE state or all of the physical NICs. In the case a response packet is received by a physical NIC in the ACTIVE state from a node, the virtual NIC 300a registers the transmission source MAC address of the response packet and the address of the physical NIC which has received the same in a MAC address table 315c in association with each other. According to the data structure of the MAC address table 315c, the destination and a transmitting NIC are associated as illustrated in FIG. 4, for example.

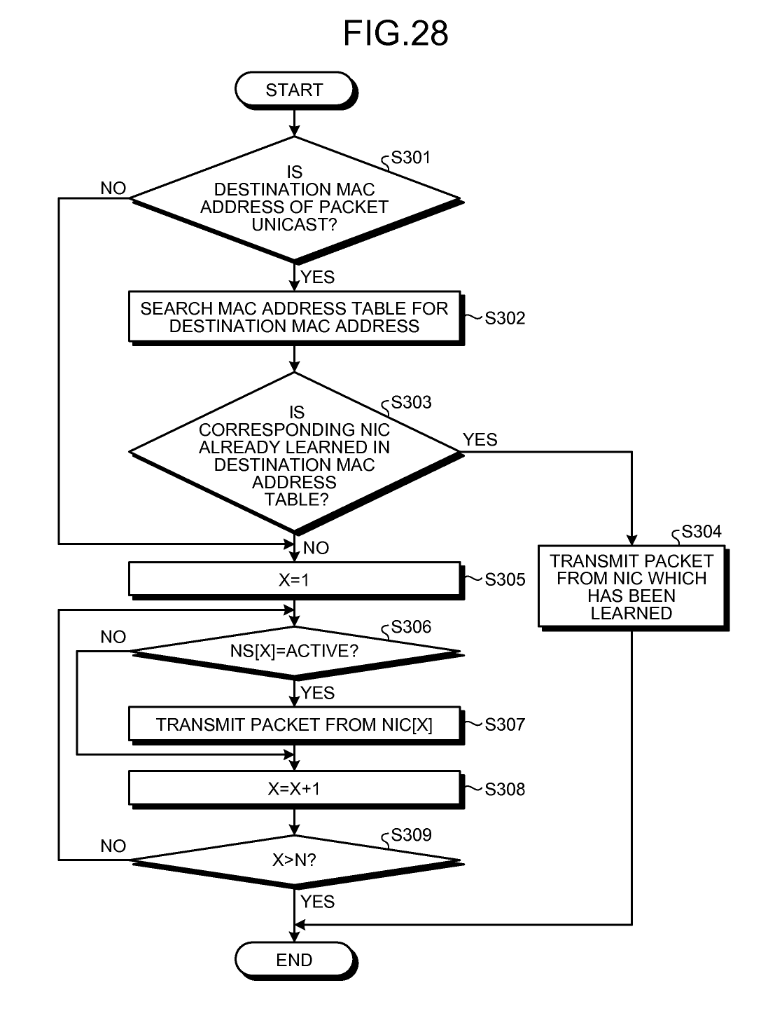

FIG. 28 is a flow chart illustrating the packet transmission procedure. The process illustrated in FIG. 28 is performed with the acquisition of a packet by the virtual NIC 300a from a virtual machine as the trigger. As illustrated in FIG. 28, the virtual NIC 300a determines whether the destination MAC address of a packet is unicast (step S301). In the case the destination MAC address of a packet is unicast (step S301: Yes), the virtual NIC 300a proceeds to step S302.

The virtual NIC 300a searches the MAC address table 315c for the destination MAC address (step S302). The virtual NIC 300a determines whether the NIC corresponding to the destination MAC address is already learned (step S303). In the case the NIC corresponding to the destination MAC address is already learned (step S303: Yes), the virtual NIC 300a transmits the packet from the NIC that is learned (step S304).

On the other hand, in the case the NIC corresponding to the destination MAC address is not yet learned (step S303: No), the virtual NIC 300a proceeds to step S305.

Step S301 will be described again. In the case the destination MAC address of a packet is not unicast (step S301: No), the virtual NIC 300a sets 1 to the value of the variable X (step S305).

The virtual NIC 300a determines whether the information set in NS[X] is ACTIVE (step S306). In the case the information set in NS[X] is not ACTIVE (step S306: No), the virtual NIC 300a proceeds to step S308.

In the case the information set in NS[X] is ACTIVE (step S306: Yes), the virtual NIC 300a transmits the packet by the NIC[X] (step S307), and proceeds to step S308.

The virtual NIC 300a sets a value obtained by adding 1 to the value of the variable X to the variable X (step S308). The virtual NIC 300a determines whether the value of the variable X is greater than the value of N (step S309). In the case the value of the variable X is not greater than the value of N (step S309: No), the virtual NIC 300a proceeds to step S306.

On the other hand, in the case the value of the variable X is greater than the value of N (step S309: Yes), the virtual NIC 300a ends the process.

Next, an effect of the system depicted in the fourth embodiment will be described. The virtual NIC 300a detects division of the network by transmitting/receiving heartbeat messages between the physical NICs. In the case division of the network is detected, the virtual NIC 300a registers the relationship between a physical NIC and a node in a reachable network in the MAC address table 315c. The virtual NIC 300a associates a physical NIC capable of reaching the connection destination and a virtual machine based on the MAC address table 315c, and performs communication between the physical NIC and the node. Accordingly, even if a single network segment is divided into a plurality of segments due to switch breakdown or interruption of a link between switches, communication between each virtual machine and each node may be maintained.

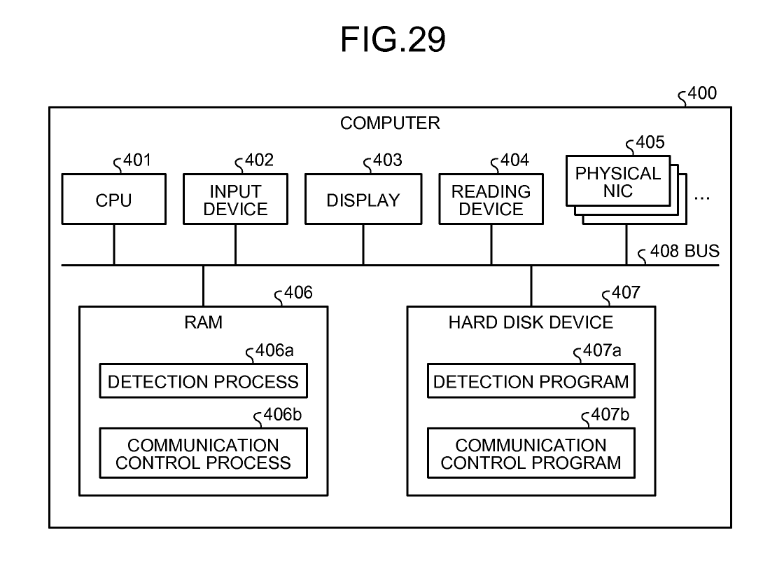

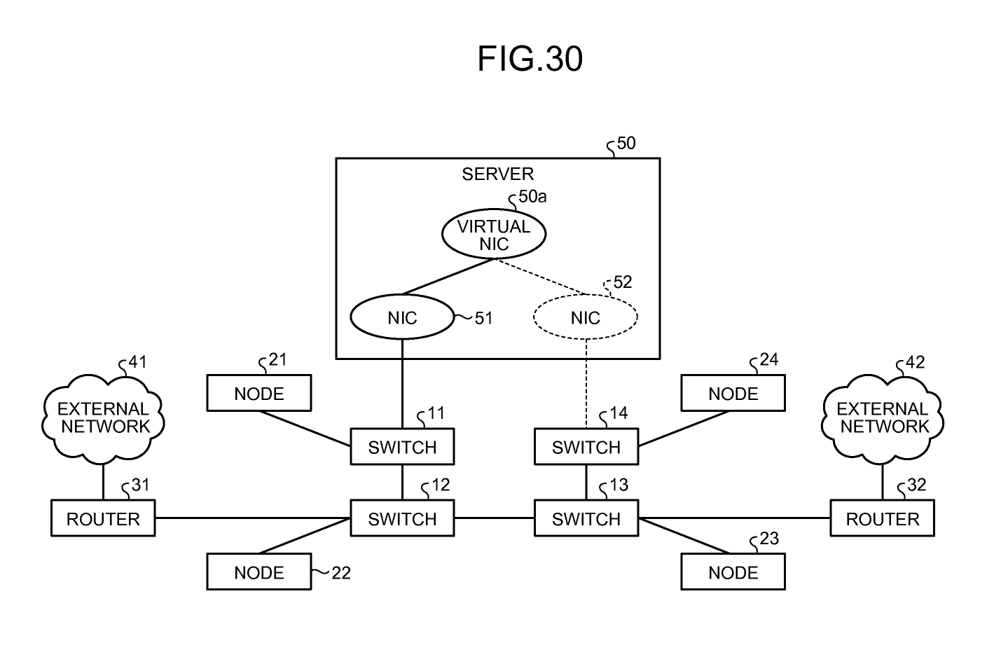

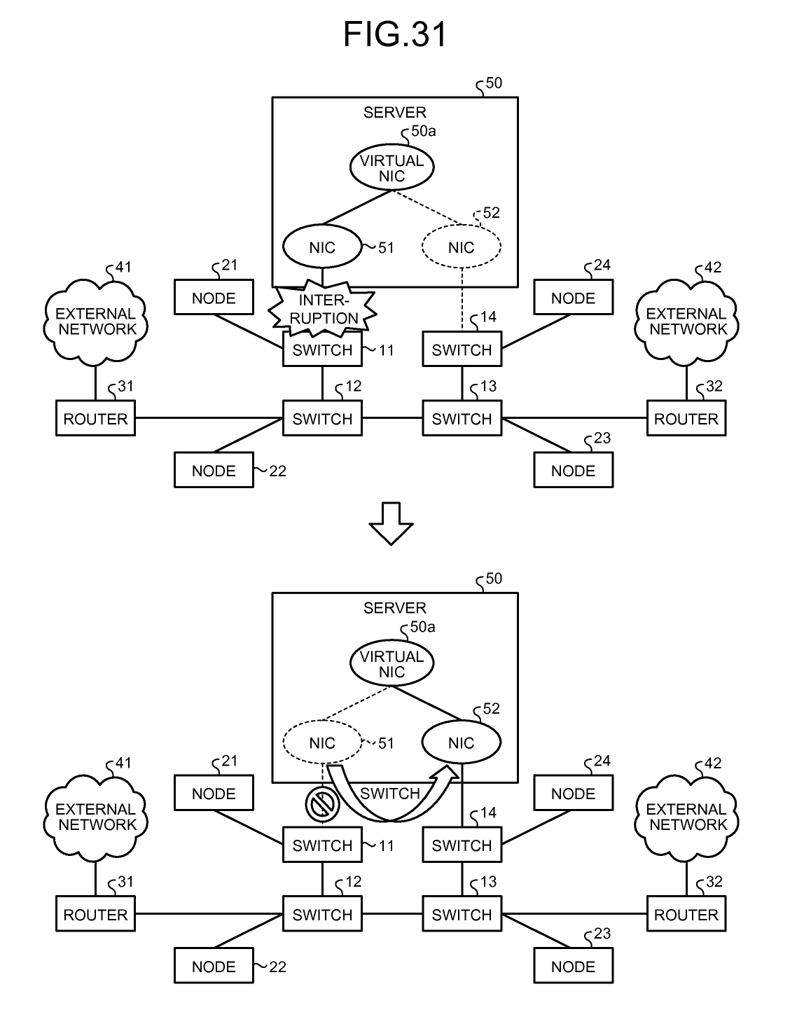

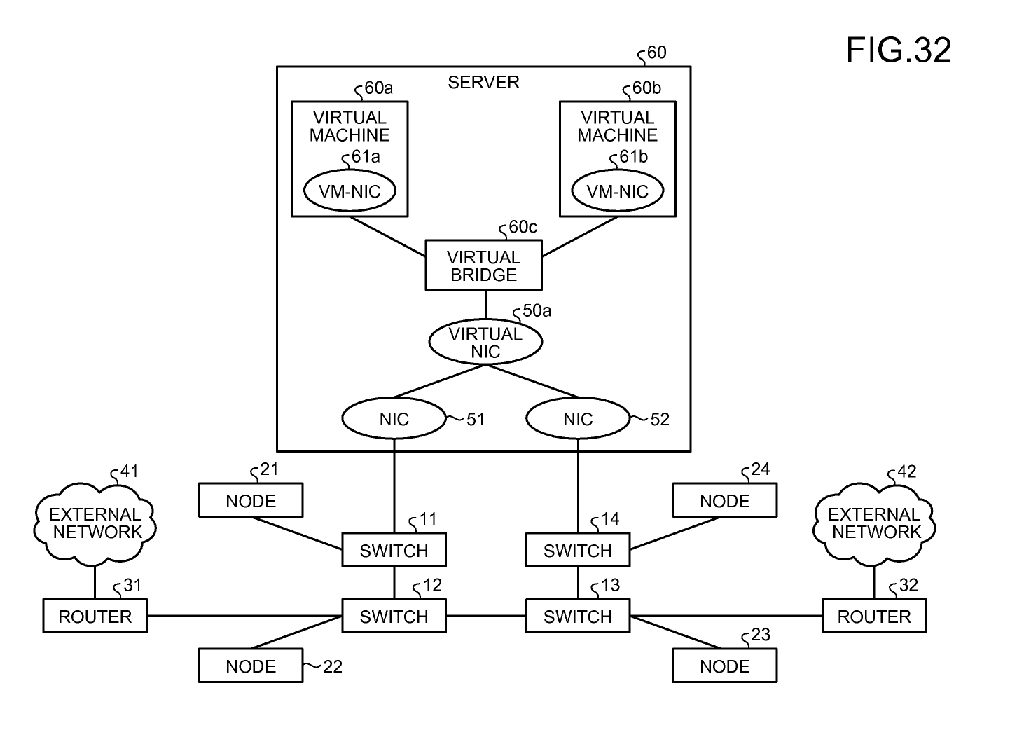

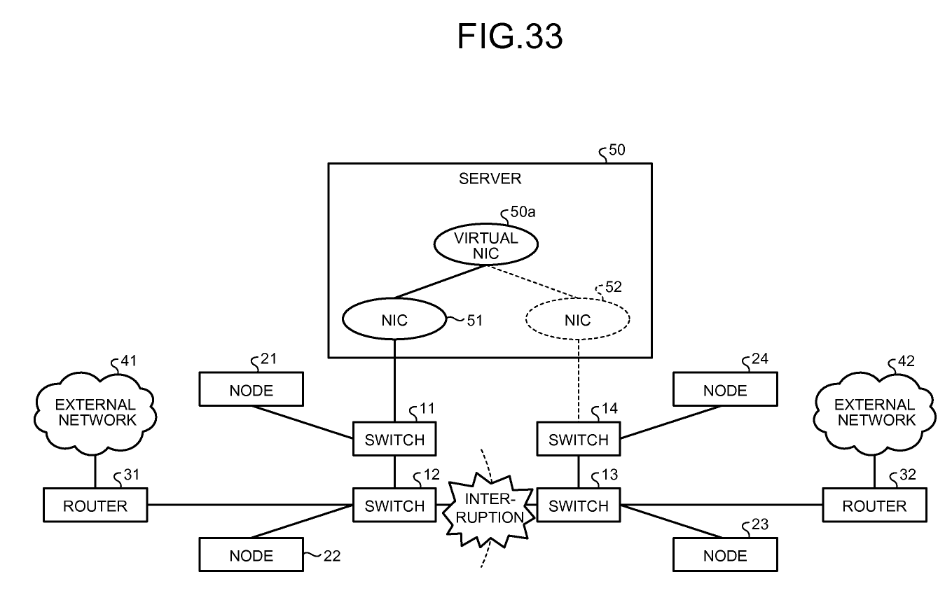

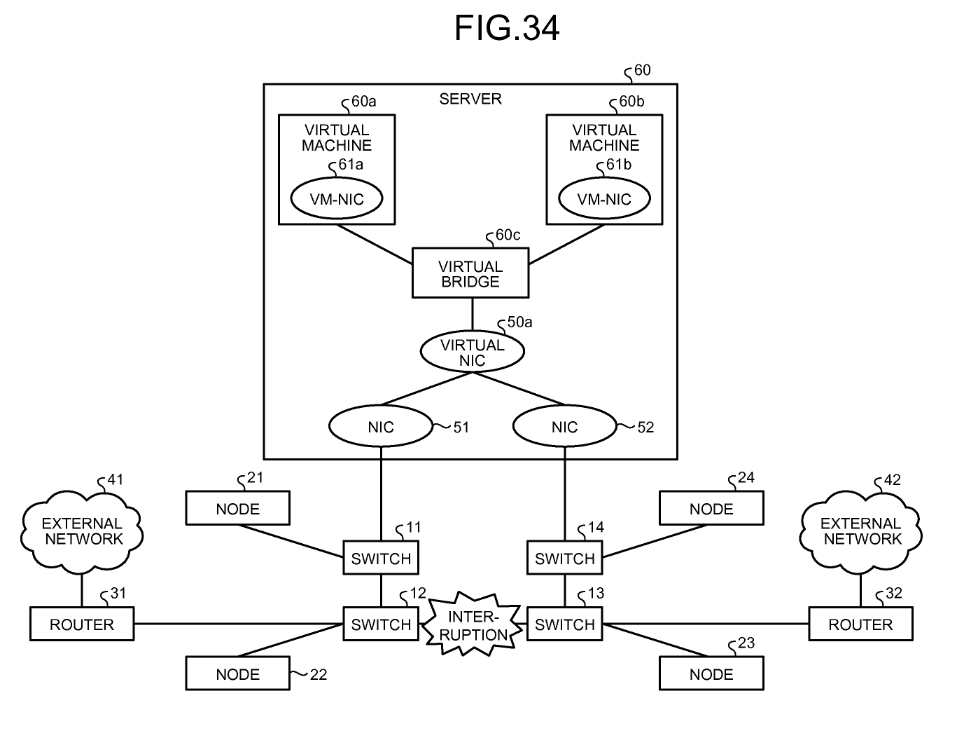

Next, an example of a computer for executing a communication control program for realizing the same function as the server depicted in the embodiments described above will be described. FIG. 29 is a diagram illustrating an example of a computer for executing the communication control program.

As illustrated in FIG. 29, a computer 400 includes a CPU 401 for performing various calculation processes, an input device 402 for receiving input of data from a user, and a display 403. The computer 400 also includes a reading device 404 for reading programs and the like from a storage medium, and a plurality of physical NICs 405 for exchanging data with other computers over a network. Moreover, the computer 400 includes RAM 406 for temporarily storing various types of information, and a hard disk device 407. The devices 401 to 407 are connected to a bus 408.

The hard disk device 407 includes a detection program 407a, and a communication control program 407b, for example. The CPU 401 reads each of the programs 407a and 407b, and develops the same on the RAM 406.

The detection program 407a functions as a detection process 406a. The communication control program 407b functions as a communication control process 406b.

For example, the detection process 406a corresponds to the detection unit 80a, and the virtual NICs 100a, 200a, and 300a. The communication control process 406b corresponds to the communication control unit 80b, and the virtual NICs 100a, 200a, and 300a.

Additionally, the programs 407a and 407b do not necessarily have to be stored in advance in the hard disk device 407. For example, each program is stored in a “portable physical medium” such as a flexible disk (FD), a CD-ROM, a DVD disk, a magneto-optical disk, an IC card or the like to be inserted into the computer 400. Then, the computer 400 may read the programs 407a and 407b from the above and execute the same.

Moreover, the virtual NICs 100a, 200a, and 300a depicted in the embodiments described above are examples of the detection unit and the communication control unit.

According to an embodiment of the present invention, communication between a server and each node may be maintained.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A calculator comprising:
a memory; and
a processor coupled to the memory, wherein the processor executes a process comprising:
detecting division of a network by communication with other communication devices, in the network, belonging to a same segment;
generating information about a correspondence relationship between each of the other communication devices and an appliance in a respective reachable network, when the division is detected; and
performing communication between a communication device and an appliance in a network based on the information about a correspondence relationship.

2. The calculator according to claim 1,
wherein a communication device to be used for communication is associated with each connection destination appliance in advance, according to a network configuration of a connection destination of a communication device, and
the generating generates information about a correspondence relationship between each communication device and an appliance in a reachable network, when the division is detected and changes a correspondence relationship between a communication appliance and a connection destination appliance associated in advance, based on the information about a correspondence relationship.

3. The calculator according to claim 1,
wherein a plurality of virtual machines operate on the calculator, and a communication device to be used by a virtual machine is associated with each virtual machine in advance, and
the generating generates information about a correspondence relationship between each communication device and an appliance in a reachable network, when the division is detected and resolves a relationship between a virtual machine and a communication device associated in advance and the performing associates a communication device capable of reaching a connection destination and a virtual machine, based on the information about a correspondence relationship, and performs communication between a communication device and an appliance in a network.

4. A communication control method to be executed by a computer, the method comprising:
detecting division of a network by communication with other communication devices, in the network, belonging to a same segment;
generating information about a correspondence relationship between each of the other communication devices and an appliance in a respective reachable network, when the division is detected; and
performing communication between a communication device and an appliance in a network based on the information about a correspondence relationship.

5. The communication control method according to claim 4,
wherein a communication device to be used for communication is associated with each connection destination appliance in advance, according to a network configuration of a connection destination of a communication device, and
the generating generates information about a correspondence relationship between each communication device and an appliance in a reachable network, when the division is detected and changes a correspondence relationship between a communication appliance and a connection destination appliance associated in advance based on the information about a correspondence relationship.

6. The communication control method according to claim 4,
wherein a plurality of virtual machines operate on the computer, and a communication device to be used by a virtual machine is associated with each virtual machine in advance, and
the generating generates information about a correspondence relationship between each communication device and an appliance in a reachable network, when the division is detected and resolves a relationship between a virtual machine and a communication device associated in advance and the performing associates a communication device capable of reaching a connection destination and a virtual machine based on the information about a correspondence relationship and performs communication between a communication device and an appliance in a network is performed.

7. A non-transitory recording medium having stored therein a program for causing a computer to execute a communication control process comprising:
detecting division of a network by communication with other communication devices, in the network, belonging to a same segment;
generating information about a correspondence relationship between each of the other communication devices and an appliance in a respective reachable network, when the division is detected; and
performing communication between a communication device and an appliance in a network based on the information about a correspondence relationship.

8. The non-transitory recording medium according to claim 7,
wherein a communication device to be used for communication is associated with each connection destination appliance in advance, according to a network configuration of a connection destination of a communication device, and
the generating generates information about a correspondence relationship between each communication device and an appliance in a reachable network, when the division is detected and changes a correspondence relationship between a communication appliance and a connection destination appliance associated in advance based on the information about a correspondence relationship.

9. The non-transitory recording medium according to claim 7,
wherein a plurality of virtual machines operate on the computer, and a communication device to be used by a virtual machine is associated with each virtual machine in advance, and
the generating generates information about a correspondence relationship between each communication device and an appliance in a reachable network, when the division is detected and resolves a relationship between a virtual machine and a communication device associated in advance and the performing associates a communication device capable of reaching a connection destination and a virtual machine based on the information about a correspondence relationship and performs communication between a communication device and an appliance in a network.
